(19) United States
(12) Patent Application Publication
(10) Pub. No.: US 2026/0220487 A1
(43) Pub. Date: Jul. 30, 2026

(54) System and method for designing and generating class architectures of neural network using a graphical programming language

(71) Applicant: NEURAL AUTOMATIONS LTD., Gatineau (CA)

(72) Inventor: Yi Guo, Gatineau, QC (CA)

(21) Appl. No.: 19/145,725

(22) PCT Filed: Jan. 15, 2024
(86) PCT No.: PCT/CA2024/050036

§ 371 Date: Jul. 3, 2025

Related U.S. Application Data
(60) Provisional application No. 63/479,767, filed on Jan. 13, 2023.

(51) Int. Cl. G06N 3/10

(52) U.S. Cl. CPC G06N 3/10

(57) ABSTRACT

A graphical programming language aiming at designing and generating modular construction of architectures of neural networks as graphs of interconnected lower-level networks is provided. The graphical programming language generally comprises graphical nodes associated to parameters which define the classes, components and interactions of components of the designed architecture of neural network. Some graphical nodes may represent sub-networks defining inner functions which are recursively analyzed at time of compilation of the neural network.

### CROSS-REFERENCE TO RELATED APPLICATIONS

The present patent application claims the benefits of priority of U.S. Provisional Patent Application No. 63/479,767, entitled “SYSTEM AND METHOD FOR DESIGNING AND GENERATING CLASS ARCHITECTURES OF NEURAL NETWORK USING A GRAPHICAL PROGRAMMING LANGUAGE” and filed at the United States Patent and Trademark Office on Jan. 13, 2023, the content of which is incorporated herein by reference.

### FIELD OF THE INVENTION

The present invention generally relates to the field of systems and methods using machine learning and artificial intelligence concepts. More specifically, the present invention relates to systems and methods for designing and generating class architectures of neural networks, such as using a graphical programming language.

### BACKGROUND OF THE INVENTION

Neural networks have been known for several years. Such networks are quite useful to solve specific problems which may lied outside of computer science realm. As such, many industries or areas may benefit from using deep learning networks. However, learning how to use or to program a neural network may be highly complex. Thus, an uninitiated user from an industry or area outside of computer science may require many hours and important efforts in training before being competent to use or program a neural network.

Neural network architectures are typically developed with regard to specific problems for which the neural network intends to solve. As an example, neural networks designed for image recognition are ill suited for analyzing EEG signals. In such events, researchers cannot rely on such solutions and must develop specific architectures for solving their specific problems.

While some users may be familiar with the concept of artificial neural networks, some users may find the logistic of building artificial neural networks difficult and time consuming. Even in cases where an appropriate architecture may have been previously published (for example on ArXiv), the instructions provided to build a working neural network are typically not trivial.

The U.S. Pat. No. 7,502,763 B2 describes a programming tool for designing an artificial neural network. The tool comprises a display interface to modify data sets for training and testing artificial neural networks and a display interface to create model data comprising a plurality of interconnected artificial neurons for the artificial neural network. While one may use the tool to model each of the artificial neurons, the disclosed tool does not allow grouping of the said neurons and to establish relationships between such groupings. The said programming tool comprises nodes which define the neurons and not the sub-networks.

The U.S. Pat. No. 10,157,045 discloses systems and methods to automatically generate code for deep learning networks. The '045 patent discloses that a front-end unit may be used to perform a number of preliminary tasks on the deep learning network. The front-end unit may further be configured to translate source programs conforming to a variety of different programming languages (C++, C, Python, Java, etc.) to the one or more intermediate representations. One or more intermediate representations may be in the form of a hierarchical Data Flow Graph and/or a Parallel Intermediate Representation, which may include a plurality of intermediate representations objects, such as nodes, which may represent layers of the deep learning network, interconnected by edges, which may represent data flow. The said invention does not allow definition of nodes by the users. The U.S. Pat. No. 10,157,045 discloses hierarchy which relates to class inheritance only. As such, this patent fails to disclose creation by users of new nodes within the system from the interconnection of lower level elements.

The US patent application no. 2018/0089592 discloses graphical representations of machine learning models to facilitate the development of artificial intelligence systems. The method discloses generating instances of machine learning models and providing the input/output between the different models. The method further discloses analyzing accuracy, speed and cost of the updated instance. The patent application relates to selected existing trained models rather than to designing network architecture.

The US patent application no. 2018/0018555 A1 discloses a system and method to build artificial neural network architectures. The properties or architectural properties of the artificial neural networks are set for each of the networks. The system uses a combiner and a random number generator to build the neural network architecture.

The U.S. Pat. No. 10,732,943 B2 discloses a compilation method and system for heterogeneous computing platform, and a runtime method and system for supporting program execution on the heterogeneous computing platform. The system generates binary file corresponding to the neural network developed in a high-level language.

The US patent application no. 2021/0406774 A1 disclose an artificial intelligence engine having an architect module to create a number of nodes and how the nodes are connected in a graph of concept nodes that make up a resulting artificial intelligence model. The system allows creating a plurality of nodes connected in a graph of the concept nodes derived from a description file. The system creates concept nodes based on a pre-trained artificial intelligence object. This patent application generally discloses user being allowed to create concept nodes in a separate pedagogical language, rather than through interconnection of element in a sub-network. Concept nodes are trained independently and are intended to decompose a complex training problem, rather than being components for the purpose of designing new network architectures.

While some of the above-mentioned systems and methods describe graphical representation of a neural network or of nodes of a neural network, none discloses or describes hierarchical and functional relationships between networks or nodes. There is thus a need for novel system and method to design and generated a class architecture of a neural network using a graphical programming language allowing defining of relationships between a high-level network and related lower-level networks, as well as relationships between the said lower-level networks. The resulting graphical representation of the class architecture generally aims at quickly generating prototypes of neural networks which may be used to solve specific real-life problems, such as, but not limited to, analyzing a new type of biological signals.

### SUMMARY OF THE INVENTION

The shortcomings of the prior art are generally mitigated by providing a system for programming a neural network using a graphical programming language.

In an aspect of the invention, a computer-implemented method for designing and generating a class architecture of a neural network using a graphical programming language is provided.

This present invention may have some coincidental application as a teaching and presentation tool. For instance an instructor may use the present system and/or method to demonstrate in real time the effect of modifying parts of a network architecture. In another aspect of exemplary use, an instructor may require students to assemble a simple architecture as an exercise. In yet another exemplary use, a researcher may use a visual graph as a figure on a poster to be used at a conference or presentation.

In one aspect of the invention, a machine-interpretable formal graphical representation of a class architecture of neural networks comprising classes is provided.

The formal graphical representation comprises hierarchical graphs representing the classes of the neural networks, each graph comprising graphical representation of nodes representing class instance of a class architecture and being defined by a set of parameters, graphical links between the nodes, each link representing a flow of data between each of the nodes and convention associated with connectors of the nodes to match dimensions between the said nodes. The machine-interpretable formal graphical representation is configured to be complied and to create specific executable network using the said formal graphical representation and a list of hyper-parameter values.

Each node may comprise at least one graphical representation of an input terminal or one output terminal, each of the terminals being associated to a class definition and comprising a convention having an ordered list of dimension names.

The machine-interpretable formal graphical representation may further comprise a downstream link between the output terminal of a first of the nodes and the input terminal of a second of the nodes or an upstream link between the input terminal of the first of the nodes and the output terminal of the second of the nodes, the linked nodes creating the hierarchical graphs and depending on the parameters, wherein the formal graphical representation is adapted to dynamically create sub-architectures depending on the set of parameters.

One or more of the links may comprise a match table connecting a terminal using different names of another terminal, the terminals having the same dimensions.

The set of parameters may define relationships between the class definition and instances of the same. Each class of the architecture may comprise a set of default parameters, the default parameters being copied in each node being an instance of the said class. Each node further may comprise a set of specific parameters.

At least one of the nodes may be a sub-network node. The sub-network node may comprise a plurality of inner nodes being connected to one another.

The node may be selected in the followings: an input or output connector, an instance of a class defined by a lower-level graph, a wrapper for an elementary operation and control flow containers. The wrapper may perform a transpose or a convolution operation.

In another aspect of the invention, a system for designing a graphical class architecture of a neural network using the machine-interpretable formal graphical representation as described above is provided. The system comprises a graphical user interface configured to display, add, move and edit graphical representations of the nodes, the terminals and the links, a configuration module to organize the parameters of the nodes, terminals and links, a library module configured to add a user-defined class and to load classes in correct dependency order; and a building module to create a computational model based on the machine-interpretable formal graphical representation.

The system may comprise a convention module adapted to automatically match dimensions between two terminals using different names, the terminals having the same dimensions. The configuration module may be configured to copy default parameters of classes to the node. The configuration module may be configured to assign specific parameter to each of the nodes. The configuration module may be configured to propagate the parameters of upper level networks to sub-nodes. The building module may be configured to generate computational models using the created architecture.

In yet another aspect of the invention, a computer-implemented method for building a graphical class architecture of a neural network using a graphical user interface is provided. The method comprises creating graphical nodes representing the class architecture of the neural network, the nodes being selected amongst any one of the followings: instance of a class of the architecture, upstream connectors, downstream connectors, flow control node and sub-network nodes, creating a wire having two ends, each end being connected to an input terminal of one of the nodes to create a downstream connector or to an output terminal of one of the nodes to create an upstream connector, setting or editing parameters associated to each created node or terminal of a node, recursively analyzing the nodes to validate the graphically represented neural network architecture using the parameters and generating computational models using the created architecture and the parameters.

The method may further comprise editing a sub-network node being an instance of a lower-level class.

The method may further comprise displaying inner structure of the lower-level class as another graph using graphical representation of nodes, terminals and wires. The generation of the computational models may further comprise executing source code associated with each of the nodes based on a template associated to type of the node as a sequence. The method may further comprise storing the generated models using a standard format of the predetermined neural network framework. The method may further comprise training the generated neural network a plurality of times using different variations of test data.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an exemplary screenshot of a graphical programming interface of an embodiment of a system for graphically designing and generating a class architecture of a neural network using a graphical programming language in accordance with the principles of the present invention.

FIG. 2 is an exemplary screenshot of an embodiment of an editing interface of a system for graphically designing and generating a class architecture of a neural network showing exemplary instances of the cascade class.

FIG. 3 is an exemplary screenshot of an embodiment of an editing interface of a system for designing and generating a class architecture of a neural network showing a loop logic container.

FIG. 4 is an exemplary screenshot of graphical architecture of a second exemplary neural network for power density spectrum calculation made using the system for graphically designing and generating a class architecture of a neural network in accordance with the principles of the present invention.

FIG. 5 is a graphical representation of chirp signals used to test the architecture of FIG. 4.

FIG. 6 is a graphical representation of a single windowed sine filter signal used to test the architecture of FIG. 4.

FIG. 7 is a graphical representation of a single windowed cosine filter signal used to test the architecture of FIG. 4.

FIG. 8 is a graphical representation of chirp signal filtered with windowed Sine to test the architecture of FIG. 4.

FIG. 9 is a graphical representation of chirp signal filtered with windowed Cosine to test the architecture of FIG. 4.

FIG. 10 is a graphical representation of a result using the architecture of FIG. 4 showing powers spectrum of chirp signals in five (5) evenly spaced frequency bands, which peaks at regular intervals.

FIG. 11 is an exemplary screenshot of project overview interface of a third exemplary neural network for basis expansion using an embodiment of a system for graphically designing and generating a class architecture of a neural network in accordance with the principles of the present invention.

FIG. 12 is an exemplary screenshot of a top level project class of the third exemplary neural network of FIG. 11.

FIG. 13 is an exemplary screenshot of a main model, also referred as “Forward” of the third exemplary neural network of FIG. 11.

FIG. 14 is an exemplary screenshot of the main model of FIG. 13, showing connector properties and a match table.

FIG. 15 is an exemplary screenshot of the main model of FIG. 13, showing property nodes of two instance of the same class.

FIG. 16 is an exemplary screenshot of an internal structure of an expansion convolution node of the third exemplary neural network of FIG. 11.

FIG. 17 is an exemplary screenshot of an internal structure of an expansion kernel node of the third exemplary neural network of FIG. 11.

FIG. 18 is an exemplary screenshot of the expansion stack and intermediate output of FIG. 2 shown in normal mode.

FIG. 19 is an exemplary screenshot of the expansion stack and intermediate output of FIG. 2 shown in visualization mode.

FIG. 20 is an exemplary screenshot of a delay node of the third exemplary neural network of FIG. 11.

FIG. 20 is a graphical representation of a sample prediction using the system defined by the third exemplary neural network of FIG. 11.

FIG. 21 is graphical representations of a first order Kernel recovered from the training data using the system defined by the third exemplary neural network of FIG. 11.

FIG. 22 is graphical representations of first order kernels recovered from input output spike trains using the system defined by the third exemplary neural network of FIG. 11.

FIG. 23 is an exemplary screenshot of project properties using the system defined by the second exemplary neural network of FIG. 11.

FIG. 24 is an exemplary screenshot of a standard filter.

FIG. 25 is an exemplary screenshot of project properties showing a L1 regularization parameter.

### DETAILED DESCRIPTION OF THE INVENTION

A novel system and method for designing and generating class architectures of a neural network using a graphical programming language will be described hereinafter. Although the invention is described in terms of specific illustrative embodiments, it is to be understood that the embodiments described herein are by way of example only and that the scope of the invention is not intended to be limited thereby.

It should be understood that the graphs described in the present disclosure describe classes architectures of neural network instead of specific networks. The present document refers to graphs as being editable visual graphs representing neural networks class architectures. The visual graphs shall not be confused with collections of executable elements, such as graphs elements defined by TensorFlow™.

Within the present document, the expressions «Neural network architecture» or «Class architecture» generally refer to parameterized objects that stipulate rules for generating computational models. The parameters are typically determined by source data format, as well as hyper-parameters. For example, in two exemplary convolutional networks, a first convolutional network may contain 5×5 filters followed by a maxpool, then followed by a 3×3 filter. A second convolutional network may comprise 8×8 filters followed by a maxpool and then followed by a 4×4 filter. Such exemplary convolutional networks should be understood to have the same architecture.

This present invention describes a graphical programming language aiming at performing modular construction of neural networks as graphs of interconnected lower-level networks. The present invention generally aims at reducing repetitive tasks typically involved in building architectures of neural networks. As an example, it may be repetitive to ensure that the dimensions are consistent throughout the neural network or to ensure that network layers are defined in the right order during prototyping as the prototyping step may include frequently adding or removing layers. The construction of interconnected lower-level networks further aims at making the designed networks visually transparent. As an example, a user may identify a network as requiring or using a classifier. Such user may then focus on the classifier, such as by zooming or expanding the visual representation of the architecture of the neural network. The classifier comprises a plurality of operations which may be displayed. As such, the densely connected layers followed by a softmax function (also known as softargmax function) of the classifier may be displayed.

The system implementing the disclosed graphical programming language may be written using any type of programming language, such as but not limited to python, C, C++, Java or any other suitable programming language.

### A. EDITABLE VISUAL GRAPHS

The system generally comprises means for visually representing a network architecture with visually editable graphs. Each graph defines a class of networks and comprises nodes representing instance of lower-level classes (see for instance section D) and connections between the said nodes. The said nodes and a data flow between the nodes may be edited and viewed using the graphical user interface.

Broadly, a node may represent, but is not limited to, an input or output connector of the graph, an instance of a class defined by a lower-level graph, a wrapper for an elementary operation, such as but not limited to a transpose or a convolution, and/or control flow containers (See Section F).

The flow of matrix data may be visually represented as connections or wires between nodes. The connections or wires may be represented as, but are not limited to, connections between an output terminal of a node of the graph and an input terminal of another node of the graph (see for instance section B), connections from an output terminal of a node to an output connector of the graph, or connections from an input connector of the graph to an input terminal of a node.

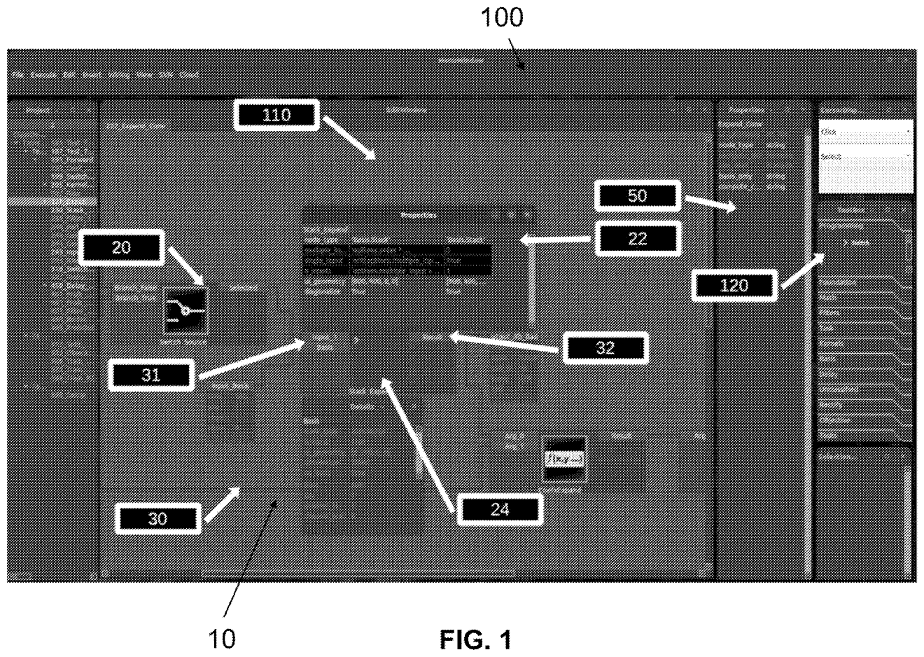

Referring now to FIG. 1, an exemplary graphical user interface (GUI) for editing a class architecture 110 of an artificial neural network 10 using a graphical programming interface 100 is shown. The GUI for editing 100 generally comprises an editing zone 110, a library of classes 120, various tools which may be docked and status displays (such as toolboxes, build status, debug information). The editing zone 110 generally provides an editing area to create, position, move and delete nodes 20 and connections (wires) 30 between nodes 20 of the neural networks class architecture 10. In some embodiments, the editing zone 110 comprises a grid. The grid may be used to snap elements, such as nodes, to the said grid. The library of classes may comprise lists of nodes. In the present embodiment, the library of classes comprises tabs, each tab representing a list of nodes.

### B. TERMINALS AND CONVENTIONS

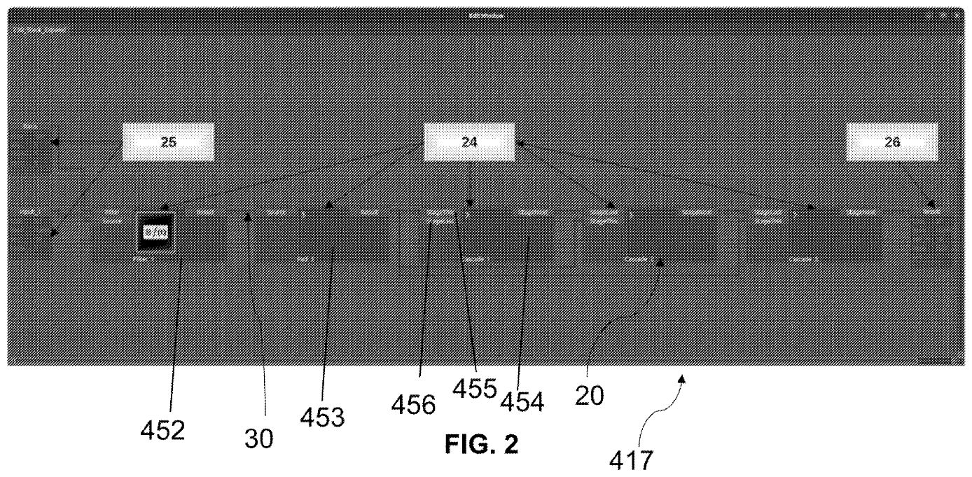

Referring to FIGS. 1 and 2, in some embodiments, the neural network 10 may further comprise visual representations of sub-network nodes or instance of lower-level classes 24. In other words, a class invoked as instance may be in defined by its own graph. The sub-network node 24 may comprise one or more terminals 31 and 32, such as an input terminal 31 and an output terminal 32. In the present embodiment, the terminals 31 and 32 are represented by connectors in their own definition graph and by terminal when the terminals 31 and 32 appear as instances. A wire 30 is connected, at each of its ends, to the terminals 31 and 32. During the editing process, wires may be automatically created from terminals by clicking the terminal name. The system 10 may be programmed to highlight broken wires which are not connected to no outputs. The highlighted broken wires may prevent a user from connecting two inputs or two outputs of lower level classes. The terminals 31, 32 are typically defined by placing connector nodes in the class definition (see, for instance, FIG. 2 and/or section D).

As an example, if a wire is connected at one end to an output terminal of a Node A and connected at the other end to an input terminal of a Node B, then Node A is considered upstream from Node B, and Node B is considered downstream of Node A.

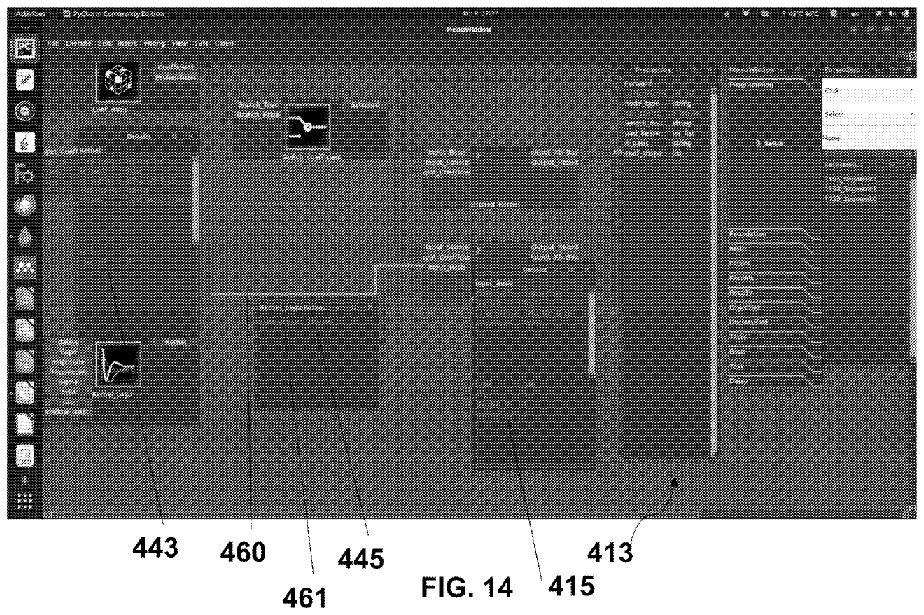

As shown in FIG. 1, terminals 31, 32 have associated dimension naming conventions (henceforth referred to as “convention”). A convention comprises an ordered list of dimension names, each of which being attached to one dimension of an input or output terminal 31, 32 (also see elements 443 and 445 at FIG. 14). A collection of such lists makes up a convention set.

The computer-implemented method further comprises re-arranging dimensions of data matrix to match dimension names between input and output terminals. For example, if an output terminal having dimensions named (“A”, “B”, and “C”) is connected to an input terminal having dimensions (“A”, “C” and “B”), the method comprises automatically transposing the last two dimensions of the data matrix. As such, the data flowing between the nodes is automatically ordered using the convention system for naming dimensions (see, for instance, FIG. 14).

Furthermore, in some embodiment, the method further comprises creating a match table attached to the wire which connects terminals using different names for the same dimensions. For example, if an output terminal having dimensions named (“A”, “B” and “C”) is connected to an input terminal having dimensions named (“A”, “X”, and “Y”), the system is unable to interpret and match the said dimensions. In such cases, the method may further comprise defining a convention table (“X=B”, “Y=C”) and associating the convention table to the wire. Using the convention table, the system may process the connection (see for instance, element 461 at FIG. 14).

A user may manually assign dimension name for every dimension on a connector. The user may further select a convention name for the connector/terminal (See Table 1). For example, a user may associate a connector to the convention “Signal”. Based on the exemplary association, the system automatically assigns dimension names based on the used convention set.

TABLE 1
Part of a configuration file for a convention set

# Define 2D Convention Set
# Where the time dimension is convolution, and the remaining dimension is
densely connected.
# instead of having to call convention here again and again
set_name = string(default =‘t_convolve_c_dense’)
t = list(default=list(‘time’))
# the Kernel makes no distinctions between input and output channel
# and t and tau.
# these meanings are assigned when kernel is connected to filter
parameter = list(default=list(‘channel’))
kernel = list(default=list(‘time’, ‘channel’))
signal = list(default=list(‘trial’, ‘time’, ‘any’, ‘channel’))
filter = list(default=list(‘time’, ‘any’, ‘channel_in’, ‘channel_out’))
filtered = list(default=list(‘trial’, ‘time’, ‘A’, ‘C’))
expansion = list(default=list(‘trial’, ‘time’, ‘cell_in’, ‘basis_last’,
‘basis_this'))
expanded = list(default=list(‘trial’, ‘time’, ‘cell_in’, ‘basis', ‘cell_out’))
cascade = list(default=list(‘trial’, ‘time’, ‘cell_in’, ‘basis_last’,
‘flattened’))
coefficient = list(default=list(‘cell_in’, ‘basis', ‘cell_out’))
projected = list(default=list(‘reserved’, ‘cell_in’, ‘cell_out’))
error = list(default=list(‘trial’, ‘singleton_1’, ‘error_type’, ‘group’))
vis_1d = list(default=list(‘trial’, ‘reserved’, ‘cell_in’, ‘basis', ‘cell_out’,
‘time_1’))
vis_2d = list(default=list(‘trial’, ‘reserved’, ‘cell_in’, ‘basis', ‘cell_out’,
‘time_1’, ‘time_2’))
complexity = list(default=list(‘complexity’))
[debug_kernel]
x = string(default =‘time’)
y = string(default =‘channel’)

### C. GRAPH SORTING

Referring to FIG. 1, the editing zone 110 may be configured to allow a user to add or create one or more nodes 20 in any order and not necessarily in a computational order. The order is typically unimportant for a data flow programming language.

In order to build or instantiate a specific computational model for an architecture (see, for instance, section G), the designed class architecture of the neural network 10 shall fulfill a number of conditions. The conditions typically require that all nodes 20 on a path to an output connector of the graph (element 26 in FIG. 2) have valid wires to all non-optional inputs of the said nodes. A node is on the path to an output connector if the node connects directly to the said output connector or is recursively upstream to another node on the path to an output connector, such as but not limited to any node upstream from a node on the path to an output connector is on the same path. The method further comprises recursively fulfilling the conditions for sub-networks 24 within the network 10 and for sub-networks 24 within sub-networks 24.

As such, the system iterates on all the input terminals of the current node, recursively adds the nodes upstream from the current nodes to a list and process all the nodes added to the list.

If all the conditions are met or fulfilled, the system executes a process to sort the graph. In some embodiments, the executed process is a known graph sorting algorithm to determine build order and to ensures that prerequisite tensors are created first. The said process generally allows the nodes and sub-networks to be sorted in the computational order to build a computational model, such as a Tensorflow™ computational model.

The method may further comprise populating an unsorted list of output terminal connectors 30 present in the graph of the network 10. The method further comprises adding to the unsorted list all the nodes whose outputs connectors 30 are connected to the input terminals of the node being analyzed. When all the nodes have been processed, the method sorts the added nodes. The sorting of the added nodes comprises iterating the nodes 20 present in the unsorted list. If all of the downstream nodes 20 of the iterated node 20 are present in the sorted list of nodes, the node is moved to a buffer or temporary list. If all the downstream nodes 20 are not present in the sorted list, the node 20 remains in the unsorted list. The sorting of the nodes further comprises iterating the nodes present in the temporary list. All the nodes that are directly upstream from the iterated node 20 (immediate children) are pushed in the unsorted list if such nodes are not present in the unsorted list. The sorting of the nodes further comprises pushing each of the nodes of the temporary list to the sorted list if all the nodes downstream from the current node are already in the sorted list. The sorting of the nodes is repeated until the unsorted list is empty or if an exception is triggered or raised. The Table 2 shows an exemplary Python implementation of the above-described graph sorting method.

Understandably, any type of graph sorting algorithm or process known in the art may be used within the scope of the present invention to sorting the nodes.

The process to sort the graph is recursively executed on the sorted sub-nodes. When the nodes and sub-nodes are sorted, the method further comprises building the network. The build process is carried out depth-first to ensure that tensor at each output terminals at a node is defined before attempting to execute the build process on any downstream nodes.

TABLE 2
Exemplary Python implementation of graph sorting

“““
Define graph sorting on any objects
the object must define find_pre, find_pst, and id_string
”””
import warnings
def id_list(collection, separator=‘\n’):
return separator.join([obj.id_string for obj in collection])
def graph_warn(sorting, ordered):
warnings.warn(‘Current Sorting Sequence:\n’ + id_list(sorting))
warnings.warn(‘Current Sorted List:\n’ + id_list(ordered))
def graph_sort(sorting_ini, excluded: list, id_string=‘’):
sorting = list(sorting_ini.copy( ))
ordered = [ ]
groups = [ ]
while sorting:
next_sorting = [ ] # remaining objects + new object from pre
pop_out = [ ]
for b in sorting:
# b: Block
pst_objects = b.find_pst( )
if not pst_objects − set(ordered + excluded):
# if all post synaptic objects are ordered.
if b in ordered:
graph_warn(sorting, ordered)
raise ValueError(id_string + ‘: Graph have Circular Connection\n’ +
‘Likely caused by: ’ + repr(b))
pop_out.append(b)
else:
next_sorting.append(b)
if not pop_out:
# stuck !
graph_warn(sorting, ordered)
raise ValueError(id_string + ‘ : Graph Sorting Stuck, may be caused by bad
outputs')
groups.append(pop_out) # entire pop out would be added as a single group
ordered = ordered + pop_out
# to keep order, you have to put units to pop out in a pop list
# then put their pre into the next sorting list.
for b_pop in pop_out:
pre_objects = b_pop.find_pre( )
for pre in pre_objects:
if pre not in (next_sorting + excluded):
next_sorting.append(pre)
sorting = next_sorting
ordered.reverse( )
groups.reverse( )
return ordered, groups

### D. HIERARCHICAL CLASS ORGANIZATION

The nodes in a visual graph may represent instances of lower-level classes. An instance of any class previously defined by a visual graph may be added to the visual representation of an upper-level network as a node. Referring now to FIG. 2, the sub-network node 24 may be expanded in a new window to reveal the internal nodes 20 and connections 30 of such sub-network node 24

It should be understood that, in the context of this document, the term “sub-network node” does not refer to any specific computational model but to an instance of an architectural class defined by another graph or to an elementary operation.

In some embodiments, the system may be configured to allow creation of one or more neural networks components or libraries. As such, the library may be user-defined classes and such user-defined classes may be added to a library of the system. In some embodiments, the library may be available to other users to be used for creating other neural network architectures. Such libraries may comprise commonly used neural network components, such as but not limited to auto-encoders and filters. As such, using predefined or stored components, the effort and time to build a new neural network architecture may be greatly reduced compared to effort and time required by a non-expert user.

In some embodiments, known graph sorting algorithms (see for instance section C) may further be used to determine the load order of classes based on prerequisite dependencies. In a preferred embodiment, a class shall be loaded after all the classes invoked by the said class have been loaded.

Referring now to FIG. 2, an exemplary GUI 200 of a sub-network 24 or a lower-level sub-node is shown. The sub-network 24 comprises a plurality of configurable node representing instances of lower-level classes, such as two instances of the “cascade” node. The sub-network 24 may be added as a node in another graph of a network 10 of another sub-network 24, such as in multi-level sub-networks. As such, an instance of the class represented by a sub-network 24 may be a component of a higher-level graph.

The sub-network 24 comprises input 25 and output 26 connectors. When the sub-network 24 is added in a graph of a network 10 of a higher lever sub-network 24, the input connector 25 and output connector 26 are displayed as input terminal 31 and output terminals 32.

### E. PARAMETER PROPAGATION

Parameters are means by which users and developers control behavior of architectural components. For example, the parameters may specify the length and order of filters or the size and the number of convolutional filters.

Similarly to known text-based programming languages, the parameters define the relationship between a class definition and its instances. Therefore, when an instance of a class is added to the visual representation of the architecture, the defined parameters are applied to the said instance. As such, the graph may determine the value of parameters of nodes inside the said graph.

The default parameters values of a node are defined by parameters associated with the graph of that class (e.g. default UI size of a filter is defined by the filter class). In the illustrated embodiment, the default list of property of a class may be managed using the graph property table 50 (shown, as an example, on FIG. 1). The graph property table 50 generally allows the user to create a list of properties which the graph depends on, along with their types and default value. In some embodiment, the list of properties may display in pop-up property tables 22 when the class is invoked as an instance. The parameters may be inherited or propagated from an upper-level class or network when the name of the parameter is the same as the name of the parameter from the upper-level network. Default and Inherited parameter values are applied automatically when new nodes are added to the graph, thus limiting the need to configure each property or parameter of an individual node.

In some embodiments, parameters with the same name may have different values in different levels of sub-graphs. For example, the upper-level network may comprise multiple instances of the same lower-level class and a parameter with the same name may take different value in each of the said instances. In such embodiments, the upper-level graph defines how the parameters are propagated. As an example, a parameter could be defined by applying an operation on two parent class properties, such as the sum of the two parent class properties.

In the situation described above, the parameters may further be explicitly specified by users as mathematical or computational expressions in a configuration table 22 or definition file (see for instance section I). The arithmetic expression may use any of the values of the parameters of the upper-level class or global parameters. Explicit parameters generally have the highest priority (see the example in Table 3). In such an example, the property table 22 comprises 3 columns.

TABLE 3
Exemplary arithmetic expressions for a sub-node

multiple_input = string(default = ‘options.order * options.cross *
not(options.compute_ND)’ )
single_input = string(default = ‘not(options.multiple_input)’ )

In some embodiments, the received arithmetic expression is parsed prior to being passed to the lower-level node. Understandably, any library or method for parsing an arithmetic expression may be used within the scope of the present invention. As an example, the parser developer by Paul McGuire may be used, typically by invoking the setParseAction method. The arithmetic expressions may further be used in association with control flows components or nodes (see for instance section F). As such, a user may create chains of dependent parameters, in order to program intricated dependency of network structure on hyper-parameters (see for instance section F).

As shown in Table 3, operations may be performed on the parameters, such as arithmetic operations. In such an example, the “multiple input” parameter is calculated by multiplying “options.order*options.cross*not(options.compute_ND)”. In such an example, the term “option” is defined as a syntax to indicate a parameter of the upper-level class/graph). The resulting value is passed as a parameter to the “multiple_input” parameters of a lower-level node.

In some embodiments, some nodes comprise an implementation of an initialization method (i.e. _init_function). As such, when a new instance of the node is created, the internal states of the node is initialized by calling the _init_function) Understandably, any other known methods to initialize the parameters could be used within the scope of the present invention.

Additional property nodes may represent complex relationships or operations between parameters. Such relationships may be difficult to represented by explicit mathematical expression. As examples, relations requiring “if” or “for” statement may be represented by the property node. A property node is typically linked to specific properties of another node. The property nodes are adapted to convert property values into data tensors. The data tensors may then be processed as data by sub-nodes. The compiler is programmed to build the sub-nodes at high priority, prior to any other nodes. The compiler may then convert the built sub-nodes value back to property, propagate such converted property to the property table of their linked nodes, before building those nodes.

In further embodiments, the system may comprise global parameters accessible by any graph. Global parameters generally aim at being used for automating training and testing (see for instance section G).

TABLE 4
Exemplary global parameter

dropout = string(default = globals.dropout)

### F. FLOW CONTROL AND META NODES

Known programming languages typically comprise expressions controlling the flow or the path of the instructions. Some examples of control or flow operations are conditional statements or loop statements. The system comprises graphical representations of various flow control operations. In a typical embodiment, the statements are associated to a type of node. Referring now to FIG. 1, Switch_Coefficient is a switch logic node. Other commonly used flow control containers or nodes may comprise variables, loops, conditional operations and dynamic calls.

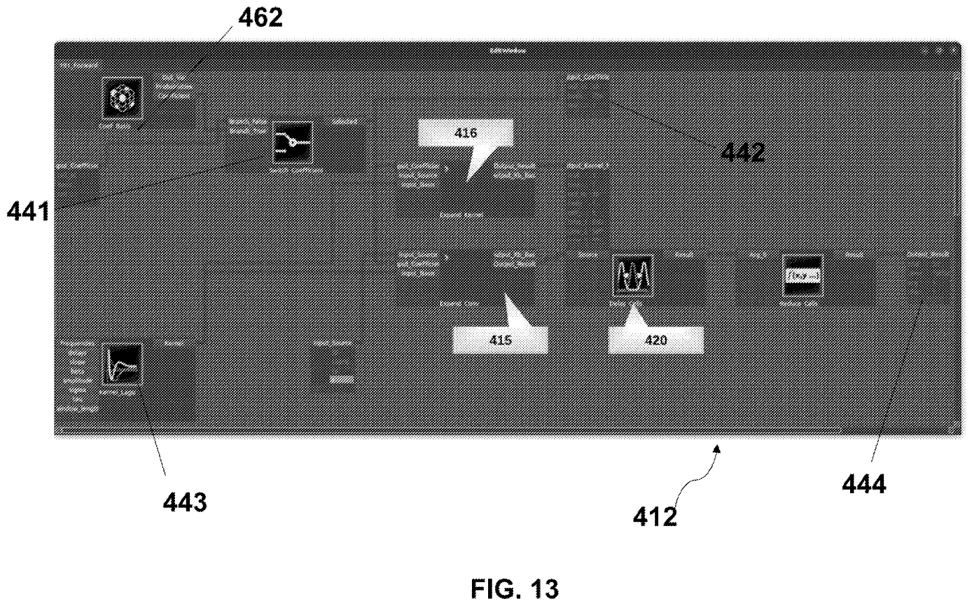

In embodiments comprising variable nodes, the variable node is represented as a plurality of input and/or output connectors all referring to the same data matrix (such as, but not limited to local variable 462 as illustrated at FIG. 13). The variable nodes may be defined as local or global variables. Local variables may only be defined inside a single visual graph. As the instances of local variables are linked to a single graph, there may be more than once instance of a local variable having different values. Every global variable having the same name refer to a single matrix. The values contained in the said single matrix are the same across different graphs.

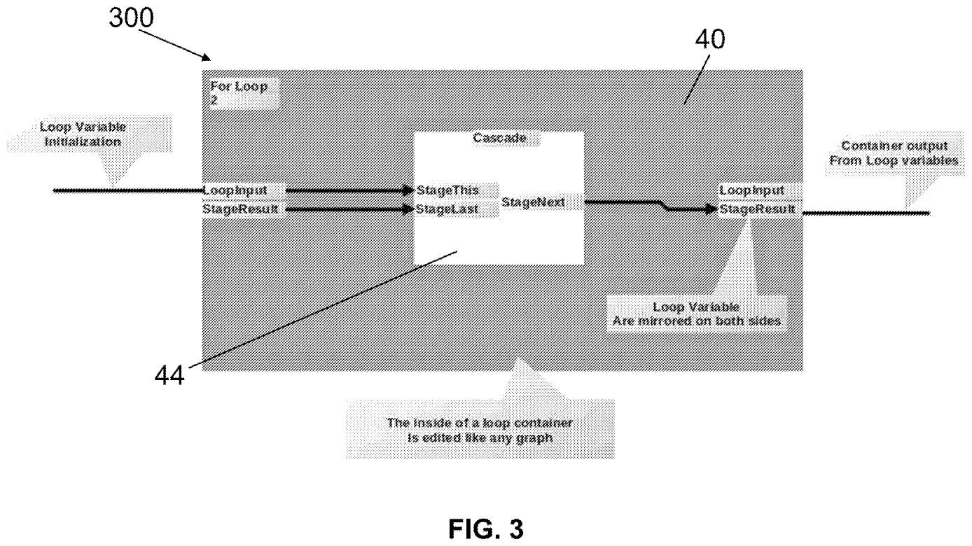

Referring now to FIG. 3, an exemplary GUI 300 of a design of a loop node 40 is shown. The loop node 40 performs multiples invocations of the cascade node 44. The invocations of the cascade node 44 are automatically performed by the loop node 40. The loop node 40 typically comprises a node parameter determining the number of iterations. For each iteration or invocation, an instance of the cascade node 44 may be created in memory using parameters associated with the iteration.

In embodiments comprising loop nodes 40, the loop node 40 is defined as a specialized type of sub-network. Unlike other sub-network types, the internal structure of a loop node 40 is visible from the parent graph. The loop node 40 may comprise loop variables nodes 42. Data may flow to and from a loop node 40 through the loop variables 42. The said loop variables 42 have a local scope within the loop node 40, meaning that the values of each loop variable 42 are different from one loop node 40 instance to the other and from one execution of the loop node 40 to the other execution.

In embodiments comprising dynamic call nodes, the dynamic call node 50 comprises a parameter for specifying the name of the node to be invoked or instantiated. Referring back to FIG. 1, an exemplary parameter named “KernelType” is used to determine the kernel function used in a filter node. In such an example, a dynamic call node 50 may be added inside a class, such as, but not limited to, dynamic call node 443 illustrated at FIG. 13. The dynamic call node 443 is configured to invoke a different kernel function producing class depending on the parameters passed.

Referring now to FIG. 1 and Table 6, “kernel functions” generally refers to a waveform, for example, a Gaussian function or Sinc function of various frequency. A kernel function may be used to reduce the size of variables by approximating a function as a weighted sum of set of known mathematical function such as, but not limited to, orthogonal Laguerre basis functions. This reduction can speed up training (see, for instance, references [3] and [4]). In the example, the parameter KernelType specifies the type of function to be generated. The said parameter may be set by a single node or may be set by a top-level class. When the parameter is set by a top-level class, the value of the parameter is propagated to lower-level classes. The said propagation generally allows easy systematic test of approximation of a target function by various kernel functions of interest.

The graphical programming language may further comprise control flows components. Understandably, any other expression statements or control flow logic components may be added to the graph of nodes within the scope of the present invention.

The present system further comprises meta-nodes 60. The meta-nodes 60 generally aim at facilitating development of additional or custom control flow components or nodes. The meta-nodes 60 are programmatically configured to dynamically generate additional connections when the graph is compiled into a computational model (i.e., at build time, see for instance section G and FIG. 3).

Referring back to FIG. 3, in such example, the system, when building the loop node 40, automatically generates the connections for passing the value of “StageResult” from one loop to the next. The section M for detailed explanation of some of the reasons using such method. The method for sorting the nodes processes the generated dynamic connections as static connections. As an example, if the loop has a value of 2 for a cascade node, the system creates two instances of the cascade nodes and connects them together such as the output of the first cascade node is connected to the input of the second cascade node. Therefore, the meta-nodes shall typically comprise one or more rules for dynamically generating connections at compilation. The ability to generate additional connections generally aim at meta-nodes to facilitate creation of additional flow control components, which generally inherit from the meta-node graphical class.

Still referring to FIG. 3, an embodiment of a loop node as a meta node is illustrated. The loop node is configured to generate, at build time, the architecture as shown in FIG. 2. The FIG. 3 also illustrates the loop node in a compact form. The internal structure of a meta node may depend on hyperparameters which are typically only present at build time (see also section G).

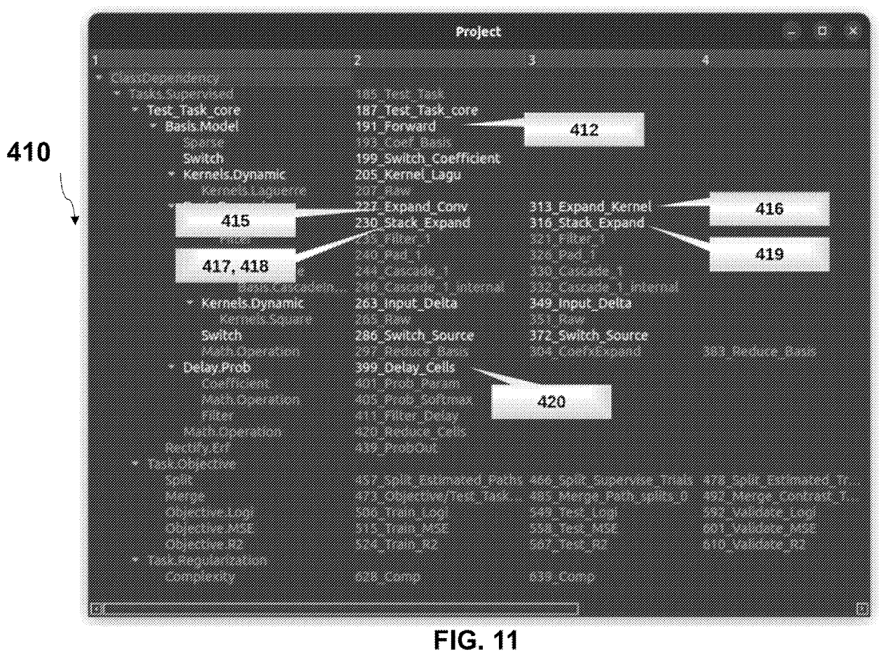

In such embodiment, meta-nodes are implemented as singletons. When building, meta-nodes create a sub-class using definitions associated with the meta-nodes. As an example, the contents of a for-loop could be used. Subsequently, the method further invokes the said sub-class one or more time. The said anonymous subclass is usually called “_core”, as exemplified on third row of the second column shown at FIG. 11.

As an alternative to the condition nodes, conditions can be attached to any node or connection. Such attached condition may allow a parameter to affect object that are dispersed over the graph. Such alternative generally aims at providing a more agile option and at reducing clutter.

### G. TRAINING, VALIDATION, DEBUGGING

The computer-implemented method further comprises evaluating and/or training in real-time or near real-time the visual representation of the architectures designed using the GUI. The evaluated and/or trained models may provide immediate feedback for a user. The evaluation and training may be done in a local environment, such as a computer, such as being in the cloud or in a cluster. The computer-implemented method may further comprise splitting trials data sets into training, validation, test and/or hold out data sets. Based on such data sets, the method further comprises computing error function for all data sets simultaneously. The method further comprises performing randomized training using trials from larger training data sets, the module responsible for these functions will be henceforth referred to as the Network Trainer (trainer for short).

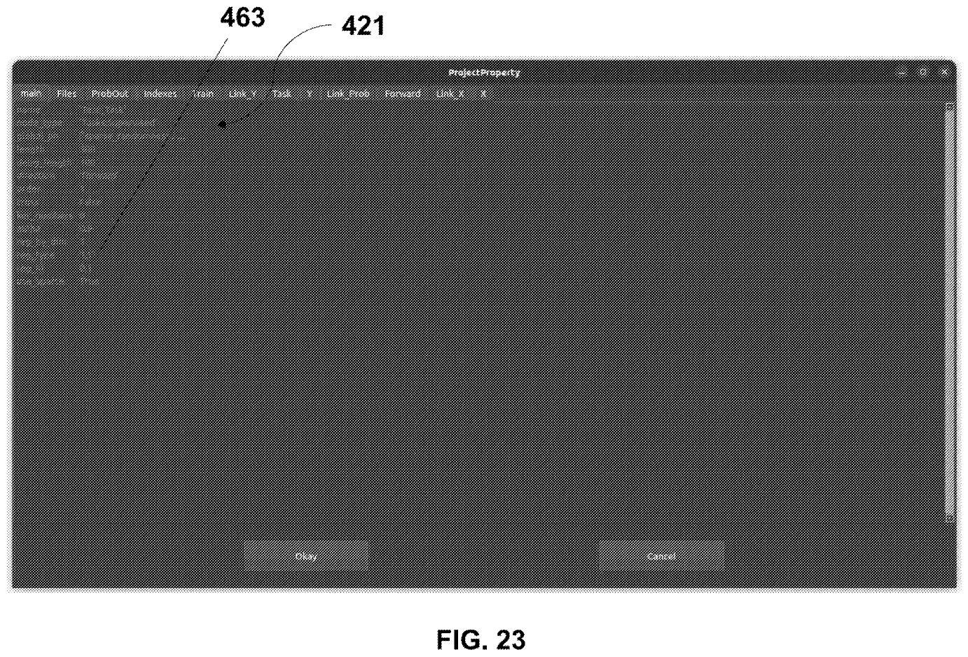

In such embodiments, a project (as illustrated at FIG. 11) is inputted in the trainer. The project typically designates a top-level class and contains hyper-parameters to be used to generate a specific computational network at build time (see FIG. 23 for an example of a top-level class and hyper-parameters).

In the general context of neural networks, hyper-parameters refer to parameters required to instantiate a fully specified computable network from possible configurations of an architecture. In the context of the present invention, additional parameters may be used to fully specify a top-level class. When applied to a sub-node instead of a top-level class, the parameters are propagated from an upper-level class (see, as an example, section D). When a class is designated as a top-level class, the parameters must be explicitly specified.

In some embodiments, the training configuration parameters may comprise ranges for trial numbers (index) for training, validation and testing sets. At the start of each run, the trainer uses the configuration parameters to automatically select (by iteration) or draw (randomly) trials in aforementioned ranges, and update global parameter which specifies trials chosen from each set.

TABLE 5
Exemplary training configuration parameters

per_worker_inputs = integer(default =1)
per_worker_outputs = integer(default =1)
workers_per_link = integer(defaul t =2)
trial_span = integer(default =24)
trial_start = integer(default =0)
# all non-fixed Group will share the same draw range
# start increase by range * worker id
[[Test]]
fixed = boolean(default =True)
size = integer(default =3)
index_start = integer(default =27)
[[Validate]]
fixed = boolean(default =True)
size = integer(default =3)
index start = integer(default =24)
[[Train]]
fixed = boolean(default =False)
size = integer(default =6)
# note: range increases automatically for each worker.

To ensure every input to the network uses the same trials, the user only has to follow every file read node with a split node. Split nodes split incoming data matrix according to the split_index parameter. The indexes of chosen trials may be passed as a parameter (such as using any method described in section E). The passed indexes are global parameters maintained by the trainer.

Data from selected trials are typically stacked together after the trial selection process, such as but not limited to along the zeroth dimension. A user may use the GUI to design a neural network without considering to which set the data belongs to. The data is split once more at the time of the final evaluation of objective (error) functions.

In yet other embodiments, the architecture may be designed to split predictions (outputs of the top-level class) along trials, in reverse order of how data were stacked after selection. The architecture may also be designed to simultaneously compute multiple type of objective (error) functions for each of training, validation, and testing set, such as but not limited to log errors, mean square errors, L1 errors, etc.

The nodes may further comprise task-input and task-output nodes. The task-input and task-output nodes are generally configured to facilitate supervised learning tasks. Task inputs node typically comprises components to perform data input and selection as described above. The task-output node is configured to compute objective functions/As such, the task-output node uses a task-input node to split supervise data, as well as aggregate the various errors (objective function type and data set) into a matrix.

In some embodiments, the method may further comprise training the neural network in a distributed environment. In some embodiments, the distributed training is performed by using cluster capabilities of Tensorflow™. In such embodiments, the Tensorflow™ support servers are run in cluster. As such, a message passing interface (MPI) may be used to allow each server to determine its own rank. The system may further set the value of a global parameter to equal this rank. The said global variable may be used to control network architecture. The rank can also be used to select different trials for each worker, as shown in the exemplary Table 5.

In some embodiments, the method may further comprise using batch training. In yet some embodiments, the method further comprises reading INI file to configure the training. In some embodiments, the method may create different variants of the training configuration files. Each variant may comprise different learning rates, number of steps, and any other relevant parameter. The method may further create different neural networks having the same architecture defined by the top-level class by varying the training configuration parameters. The method is further configured to iterate through the variants configuration files and to run training instances, each instance being associated to a distinct variant of training configuration parameters. Understandably, any other know method to run the training in batch may be used within the scope of the present invention.

In some embodiments, the method may further comprise attaching a debugging monitor to wire or connection of any graph. When the said class containing the wire is instantiated during training or evaluation as a sub-network at any level, the value of the data matrix passing through the wire will be automatically plotted and/or saved after every N steps as required by the user. The format of the plot may be set for each named convention type (see, for instance, Table 1).

### H. REVERSE GRAPHS FOR MANUAL GRADIENTS

In some embodiments, the system uses an automatic gradient belt to solve simple problems. In other embodiments, the system may use a manual gradient. The manual gradient is typically used in architecture designed to solve complex problems. In some embodiments, such as when a non-continuous function is used, the use of a manual gradient may be required as automatic gradient either does not exist or would be incorrect. In yet other embodiments, when a manual gradient is simple and an automatic gradient would be very complex, a manual gradient may improve performance.

As an example, the automatic gradient belt would fail when using sampled probabilistic functions, like f′x, y|=y:[x+RAND:0.1|:>0| where rand is a uniform random variable. The automatic gradient is always zero because of the inequality, which has no gradient.

The method further comprises creating a reverse graph for the said node to manually define the gradient. A reverse graph may be defined as a graph having input and output terminals 31, 32 in reversed order.

### I. CLASS DEFINITION FILES

In a typical implementation, the visual format of the graph is converted to a text file, such as but not limited to an INI file or an XML file. The text file comprises a description of the sub-nodes and connections/relationships of the class. Text files containing such descriptions will be henceforth referred to as class definition files.

As an example, the ConfigObj library may be used to read/store the parameters in an INI file. In the Table 1 below, an exemplary INI file containing configuration parameters of a sub-network is shown.

In such an exemplary embodiment, the GUI editor may save graphs as Definition Files. Alternatively class definition files can be amended or written manually by users. However, Class Definition Files must respect a predetermined syntax which is acceptable by the system (See the Following Example in Table 6 and Section I). As long as the syntax is compatible, the system will be able to load the class defined by the file, therefore allowing a user to specify architectures manually, bypassing the GUI. The Class definition file and the corresponding graph are different representation of the same object, Editing a Class definition files manually can achieve essentially the same goals as editing the class in the GUI.

In yet other embodiments, Class Definition Files may be added to version source control software, such as but not limited to SVN or GIT. Understandably, any known method of reading/storing non-transient parameters may be used within the scope of the present invention.

A class definition file is typically a tree of configurations strings. For an example of how such strings are organized, see Table 6. Understandably, any type of file may be used to fully describe a graph, including the parameters of the various nodes 20 within the upper-class network (see, for instance, section E), and the associated connections (see for instance section B).

TABLE 6
Exemplary INI file comprising configuration parameters of a sub-network

| | |
|---|---|
| node_type | =string(default=‘Filters.Standard’) |
| [Waveform] | |
| node_type | =string(default=‘Kernels.Dynamic’) |
| ui_geometry | =int list(default=list(200, 200, 0, 0) ) |
| [Filter] | |
| node_type | =string(default=‘Filter') |
| ui_geometry | =int list(default=list(1000, 500, 0, 0) ) |
| [Switch_Diag] | |
| node_type | =string(default=‘ Switch’) |
| ui_style | =string(default=‘auto’) |
| ui_size | =string(default=‘auto’) |
| switch_cond | =string(default=‘options.diagonalize’) |
| ui_geometry | =int list(default=list(600, 400, 0, 0) ) |

[[Branch_False]]

| | |
|---|---|
| node_type | =string(default=‘Connector’) |
| convention | =string(default=‘filter’) |

[[Branch_True]]

| | |
|---|---|
| node_type | =string(default=‘Connector’) |
| convention | =string(default=‘filter’) |
| [Source] | |
| node_type | =string(default=‘Connector’) |
| is_input | =boolean(default=True) |
| ui_geometry | =int list(default=list(700, 600, 0, 0)) |
| convention | =string(default=‘signal’) |
| [Result] | |
| node_type | =string(default=‘Connector’) |
| is_input | =boolean(default=False) |
| ui_geometry | =int list(default=list(1500, 200, 0, 0)) |
| convention | =string(default=‘signal’) |
| [Transposed] | |
| node_type | =string(default=‘Connector’) |
| is_input | =boolean(default=False) |
| ui_geometry | =int list(default=list(1500, 400, 0, 0)) |
| convention | =string(default=‘signal’) |
| [Kernel] | |
| node_type | =string(default=‘Connector’) |
| is_input | =boolean(default=False) |
| ui_geometry | =int list(default=list(1000, 0, 0, 0)) |
| optional | =boolean(default=True) |
| [Link_Diag_True] | |

| | |
|---|---|
| pre | =string(default=‘self.Waveform.Kernel’) |
| pst | =string(default=‘self.Switch_Diag.Branch_True’) |

[[match_table]]

| | |
|---|---|
| channel_in | =string(default=‘channel’) |

[Link_Diag_False]

| | |
|---|---|
| pre | =string(default=‘self.Waveform.Kernel’) |
| pst | =string(default=‘self.Switch Diag.Branch_False’) |

[[match_table]]

| | |
|---|---|
| channel_out | =string(default=‘channel’) |

[Link_Filter_Source]

| | |
|---|---|
| pre | =string(default=‘self.Source’) |
| pst | =string(default=‘self.Filter.Source’) |

[Link_Filter_Filter]

| | |
|---|---|
| pre | =string(default=‘self.Switch Diag.Selected’) |
| pst | =string(default=‘self.Filter.Filter’) |

[Link_Result]

| | |
|---|---|
| pre | =string(default=‘self.Filter.Result’) |
| pst | =string(default=‘self.Result’) |

[[match table]]

| | |
|---|---|
| any | =string(default=‘A’) |
| channel | =string(default=‘C’) |

[Link_Transposed]

| | |
|---|---|
| pre | =string(default=‘self.Filter.Result’) |
| pst | =string(default=‘self.Transposed’) |

[[match_table]]

| | |
|---|---|
| any | =string(default=‘C’) |
| channel | =string(default=‘A’) |

[Link_Kernel]

| | |
|---|---|
| pre | =string(default=‘self.Waveform.Kernel’) |
| pst | =string(default=‘self.Kernel’) |

### J. A FIRST EXAMPLE

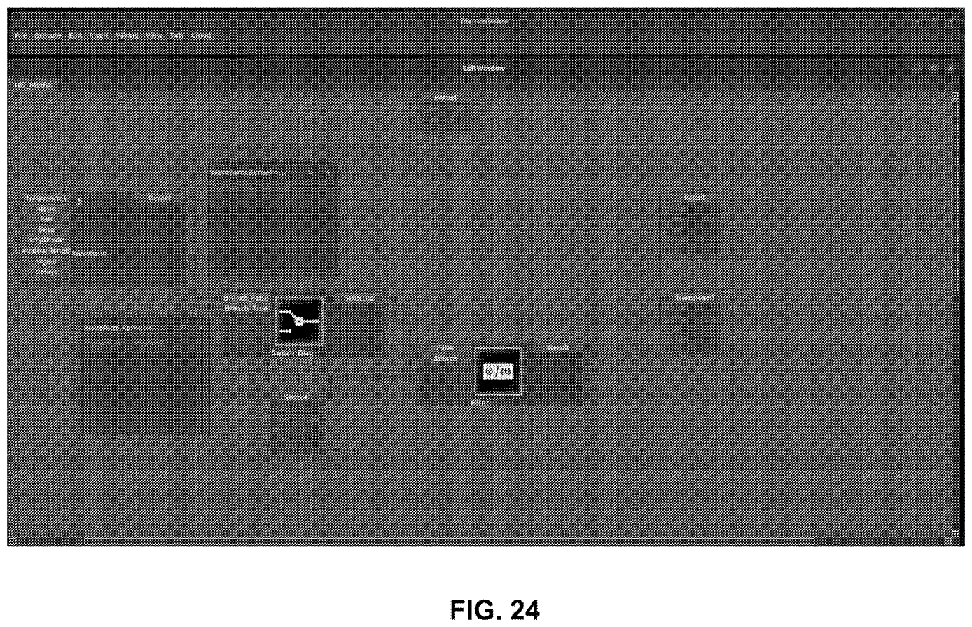

Table 6 shows a standard filter with a select-able kernel type as illustrated at FIG. 24. The illustrated architecture provides an example of how a user can create a simple filter using either the GUI or by editing a definition file.

The illustrated configuration file generally defines a standard convolution filter for the components of the graph. The configuration file may comprise the following sections corresponding to connector nodes: source, result, transpose. The said sections generally define input and output connectors of the visual graph (which also appear as terminals when the graph is invoked as a node). The source section sets the parameters of the signal to be filtered, the result section sets the parameters of the output of the operation and the transpose section sets the parameters the transposed results. The transposed results are typically used when the filter is connected to itself in sequence (with transpose of one filter connected to source of the next), such as in a loop.

The next section is waveform. The waveform section represents a callback node. The callback node is configured to invoke a lower-level class by name, such as a class described by the KernelType property of the standard filter graph. The waveform node outputs the kernel or waveform used to filter the input signal. All the kernels are designed to have the output convention of [time, channel].

The next section of the exemplary configuration file is the Kernel section. The said section defines an extra output terminal/connector, kernel, which communicates the output of the waveform as an output of the graph.

The next section is “switch_diag”. The said section defines a control flow node comprising two inputs, “branch_true” and “branch false”. The control flow node is configured to select one of the inputs. The selection may depend on the “diagonalize” property of the graph, as illustrated in Table 6. The “diagonalize” property is an example of a property being expressed as a function of the value of properties of upper-level graphs. This switch governs how different input channels are processed by the filter.

The parameters of the configuration file may be used to overwrite parameters inherited from an upper-level graphical class. In the above exemplary configuration file, the property “switch_cond” of the “switch_diag” node is overwritten by the property “diagonalize” of the “Filters. Standard” Graph (see, for instance section E). The overwriting may be performed either by editing the definition file or by editing the respective row of the configuration table in the GUI.

The configuration file further comprises a “Filter” section. In the exemplary configuration, the “Filter” section defines an elementary operation, in this case, a 2D convolution. In such an example, the 2D convolution is defined using the Tensorflow™ library in a lower-level language such as but not limited to Python or C++. In such an example, the 2D convolution calls tf.nn.depthwise_conv2d (if diagonalize is true) or tf.nn.conv2d (if diagonalize is false) when a signal is present at input terminals based on node properties.

Another section describes connections or wires. For example, the connection “Link_Diag_True” describes a wire from the “Kernel” output terminal of Waveform Node (not the same as the “Kernel” terminal with the same name on the Standard Filter Graph), to the “Branch_True” input terminal on “Switch_Diag” node.

The configuration file further comprises a match table. The match table generally transforms the “channel” dimension (axis) on the input end to the “channel in” dimension of the output end (see for instance section B for description of match tables). While both branches may receive input from “Waveform”, in such an example, each branch may have a different match table. The True Branch permute “channel” on “Waveform.Kernel” (dimension 1) to “Channel_in” on “Filter” (dimension 2). The False Branch permutes the “channel” to “Channel_out” (dimension 3). The said permutation allows to accommodate the different filter format for tf.nn.depthwise_conv2d and tf.nn.conv2d, see above.

It should be noted that throughout the present document, any reference to a dimension is indexed at zero based. Understandably, any other index of reference may be used within the scope of the present invention.

### K. IN USE

In use, a user generally designs a neural network architecture using the above-described graphical user interface or system to solve a specific issue. On a graph representing an architectural class, the user uses a GUI to create graphical nodes representing variables, input connectors, output connectors, meta-nodes for flow control, and sub-network nodes. Graphical nodes contain input and output terminals of different types. The user further uses the GUI to create wire having two ends, each end being connected to an input or output terminal of a node. The user may further use the GUI to add or modify parameters associated to each node or each terminal of a node.

Sub-network nodes represent instance of lower-level classes (including elementary operations). The system is configured to display the inner structure of the lower-level class as another graph (see for instance FIG. 2). The inner structure of the class shown as an example comprises the same set of components as the upper-level graph, including further lower-level sub-network nodes to be called recursively (such as cascade in FIG. 2) and connections between the said nodes of the inner structure. The user may at any time add a graph to the library and invoke instances of the said added graph in any other graph, as long as the invocation does not result in circular definition.

The computer-implemented method further comprises validating the neural network architecture designed in the GUI by recursively analyzing the nodes. The method further comprises generating computational models from the designed architecture in real time or near real time. The construction of a fully specified neural network model may comprise executing the source code for each of the node based on a template of the said type of node in the correct sequence. The model is then stored using a standard format of the predetermined neural network framework, such as a Tensorflow™ model file.

The method further comprises training the generated neural network, such as training the neural network as batch or a plurality of times using different variations of test data.

### L. A SECOND EXAMPLE

The second example of a use of the present invention is provided only for illustrating some of the capabilities of the said invention. The said example is in no way limitative of the scope of the present invention and presented only for exemplary purposes.

The second example makes use of the present invention to develop a tool for quickly calculating the power spectrum of a signal. Power spectrum generally represents the shift in frequency of a signal over time. Such calculation generally uses Fourier transformations. Such calculations are widely used in the area of signal processing [1], including in the area of voice recognition (see reference [2].

Referring to FIGS. 1-7, an exemplary neural network architecture for automatically calculating the power spectrum of a signal 400 and the related signals are illustrated. While the present example does not comprise trainable parameters, the illustrated neural network architecture 400 shows how artificial neural networks can be used outside of typical known uses of machine learning algorithms.

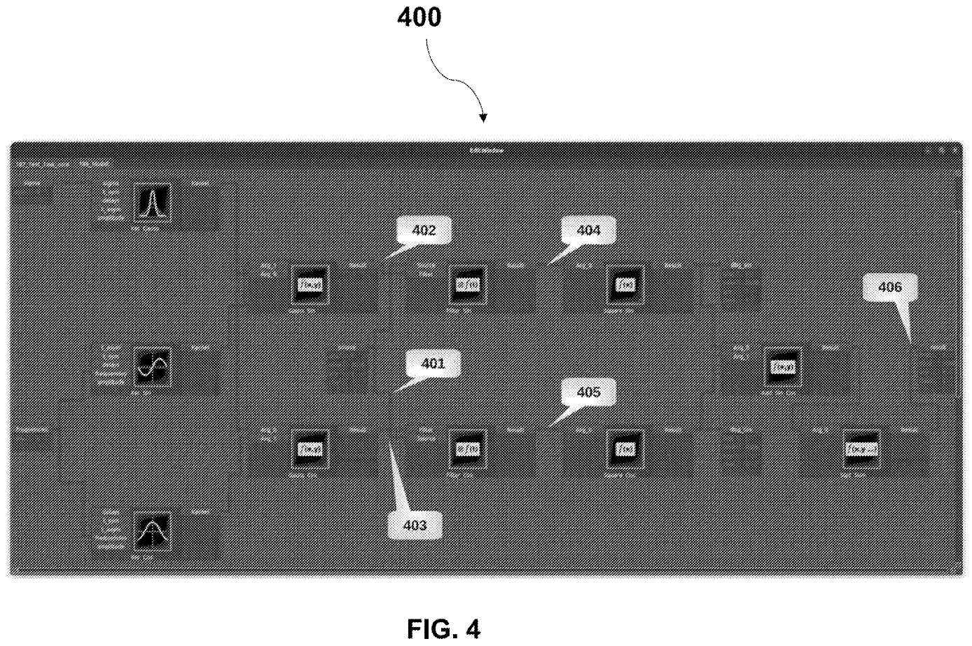

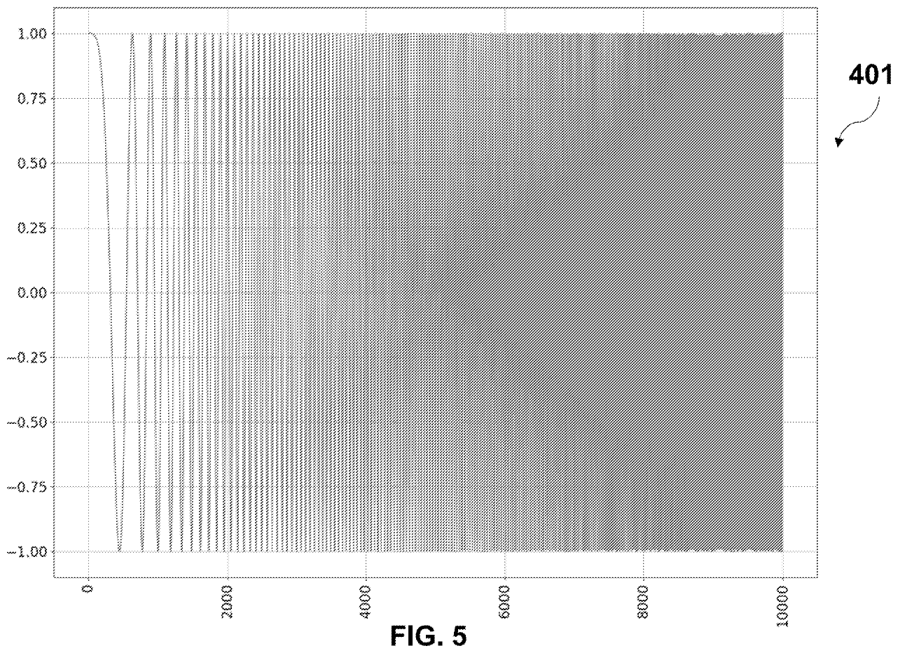

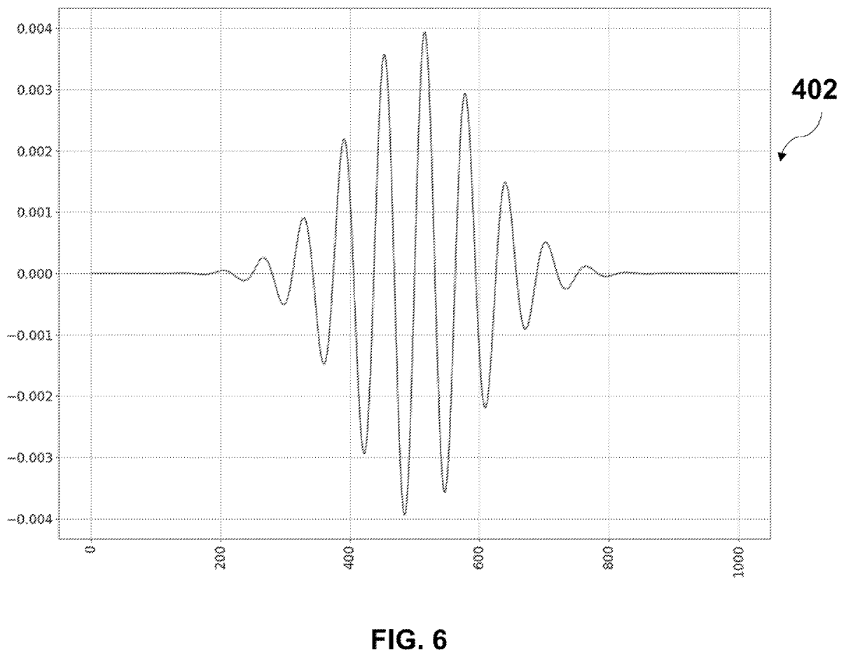

The exemplary neural network 400 comprises two first layers configured to multiply a Gaussian signal with Sine and Cosine signals respectively to create windowed Sine 402 and Cosine 403 signals (shown at FIGS. 3 and 4). An input signal 401 is convoluted with (or filtered using) the windowed signals 402 and 403. Where the frequencies match, the signals resonate and are amplified as shown at 404 and 405 (shown at FIGS. 5 and 6).

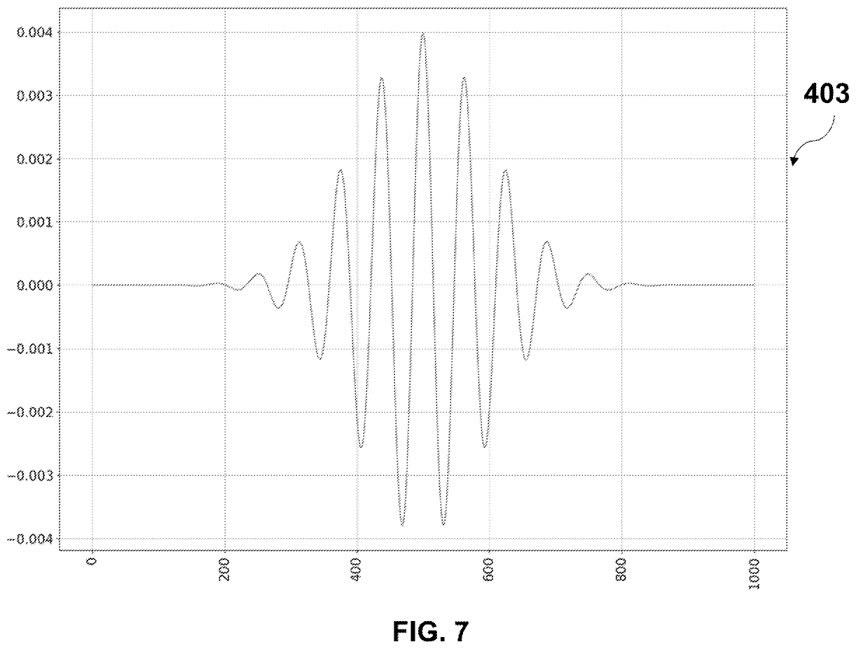

As sin²(x)+cos²(x)=1, the network calculates the magnitude by taking the sum of squares. The sum of squares cancels out the oscillating component leaving only the power of the signal at each frequency over time 406 (see FIG. 7).

Referring to FIG. 2, chirp signals are used as test because the frequency of the chirp signals shift from low to high at a constant rate. Referring to FIGS. 3 and 4, exemplary windowed sin and cos filters are illustrated, respectively. The neural network 400 simultaneously computes filters at multiple frequencies. The FIGS. 3 and 4 only illustrate one windowed sin signal for the sake of clarity. Referring to FIGS. 5 and 6, chirp signals filtered with windowed sine (FIG. 5) and cosine (FIG. 6) are illustrated. Filters with different sinusoidal frequencies resonate at different locations. The FIGS. 5 and 6 only illustrate one windowed sin signal for the sake of clarity. Referring to FIG. 7, a resulting signal of power spectrum of chirp signals is illustrated. FIG. 7 shows the power at different frequencies peaks at fixed intervals, as expected (other than the transient artifact at edges).

### M. A THIRD EXAMPLE

Orthogonal Basis expansion is a well-known non-parametric modeling technique [3]. The relation between two arbitrary signals (henceforth called input and output) can be modeled as a series of Kernels, such Kernels predict the output when convoluted with the input (FIG. 2.1, page 31 of [3]). First order kernels are kernel with one dimension and generally explain the output by delaying and scaling the input. Second order kernels comprise two dimensions. Such second order kernels generally explain the relation between the input at two different time points and the output. The same may be applied to kernels having n dimensions. Such concept is illustrated in the equation below:

$$F \text{?} = {k}_{2} + \text{?}$$

$$\text{?} \text{indicates text missing or illegible when filed}$$

As such kernels span the time domain, the kernels are parameterized using a very large number of parameters. To make the problem tractable, kernels are often represented by a weighted sum of basis functions (Eq. 2.179, page 102 of [3]). A basis is a series of functions, usually designed to be orthogonal, as in that no basis function can be represented as a weighted sum of other functions in that basis. The basis functions are also often designed so that having an increasing number of the said functions tends to produce an ever better approximation of any arbitrary function as a weighted sum. Basis functions include sinusoidal basis in a closed interval, piece-wise basis, splines, or in the case of the example, Laguerre polynomials in a semi-closed interval. Second order basis can be produced by multiplication of each pair of first order basis. As the first order basis are orthogonal, the product will also be orthogonal to other products. The third order basis can be computed recursively by multiplication of each pair of first and second order basis. (see 2.3.2, page 107, reference [3]).

Basis expansion algorithms have been previously used to model spike trains generated by neurons. The present example uses the disclosed invention in to resolve a previously published modeling problem (see reference [4]) using an ANN. The present example has a level of complexity sufficient to demonstrate a number of previously described features as described above. The said problem is not as complex as problems involving real-world data, which are too large to be illustrated as examples in the present patent application.

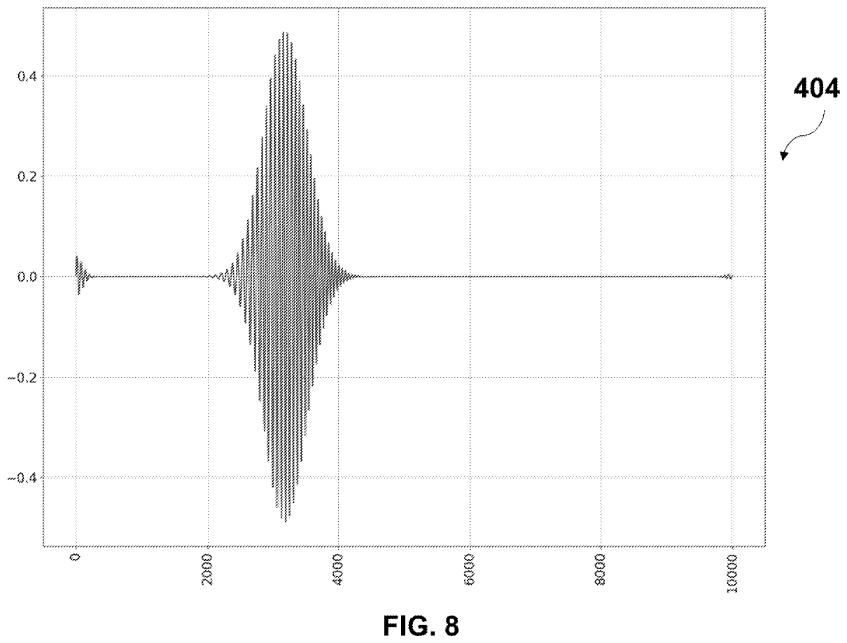

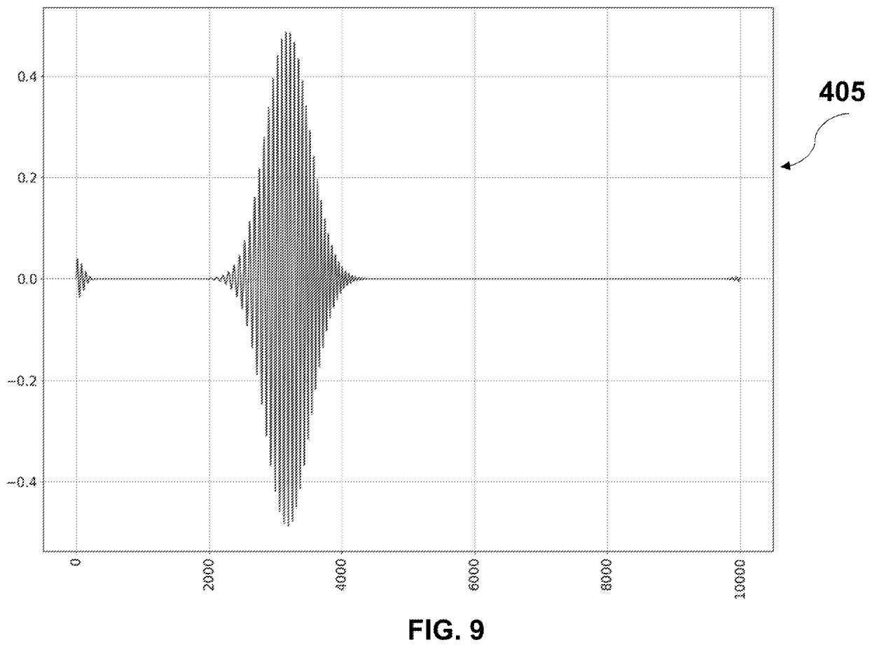

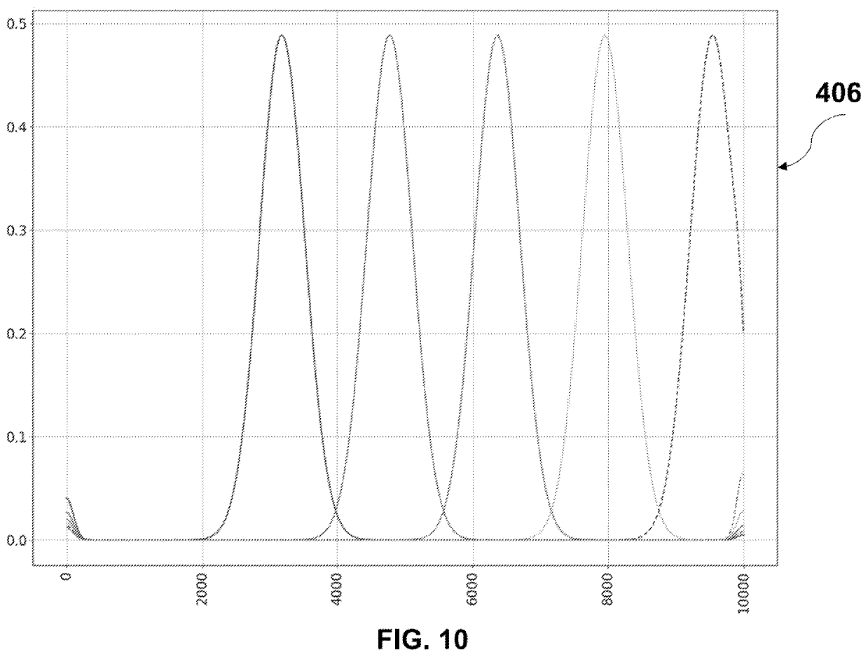

Referring to FIG. 11, an exemplary interface 410 displaying project overview and navigation is illustrated. A first column of the interface 410 illustrated some or all of the classes involved in the project. The classes may comprise dependencies, as illustrated by indentations at FIG. 8. The subsequent columns list the instances of the classes shown in the first column. In the illustrated embodiment, classes defined in other languages, such as built in classes and elementary operations, are shown in gray and classes defined as graphs, and so can be edited, are shown in white.

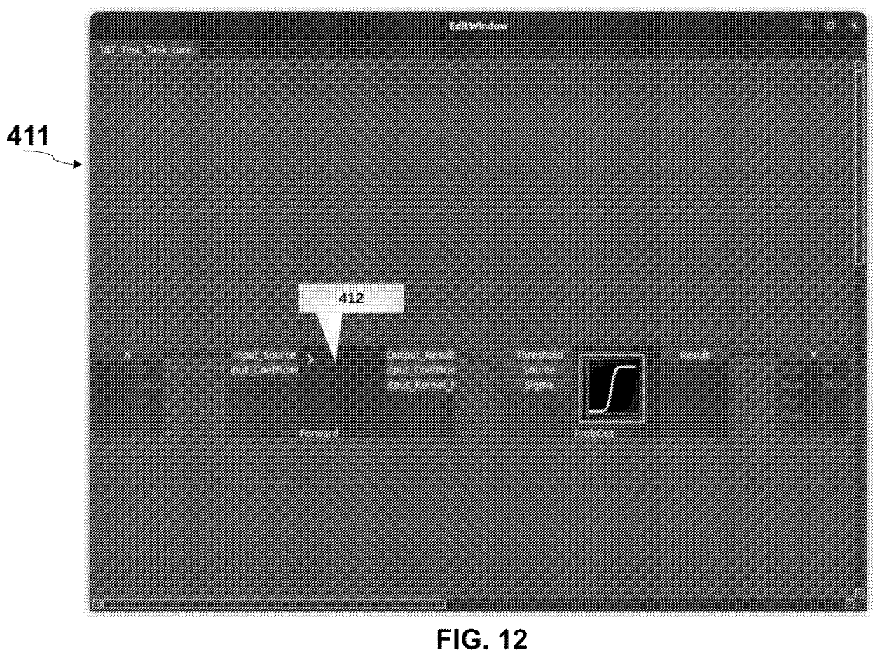

As described above, the classes of the neural architecture can be hierarchical (or part of a hierarchy). Still referring to FIG. 8, the overview portion of the interface 410 illustrates the Basis.Model class. Such class is defined using instances of Switch and Kernel.Dynamic classes As such, the instance of a Basis.Model may be created and labeled. In the present example, the instanced is labeled 191_Forward 412, shown at FIG. 12.

In the illustrated embodiment, the first word of the class names may be considered name spaces, indicating the general category of the class and facilitating searches. Furthermore, in some embodiment, a number before the instance may be provided, generally indicating a unique serial number assigned by the system to prevent confusion in references of instances.

Referring now to FIG. 13, an embodiment of a main model 412 is illustrated. The main model 412 may also be referred to as the forward model. The main model 412 is a strictly feed forward Neural network model. The graph shows the configuration of the architecture for a third order kernel expansion in the context of hyper-parameters set in project properties 421 (shown at FIG. 23). In such an example, the order of the kernel may be set with a single parameter in the project properties area 421. Therefore, the network should be considered to maintain the same architecture even if the order changes.

Referring to FIG. 13, a selector 441 picks between internal or external basis coefficient (weight for basis functions). Understandably, some graphs of the present class use a shared coefficient supplied by the upper level class. The graph further comprises additional output Output_Coefficients node 442, which is configured to supply the coefficients to an upper level class if needed. On the bottom left corner, the Kernel. Lagu node 443 supplies the Laguerre basis functions (as an example, by recursion in numpy, a Python library for math operations).

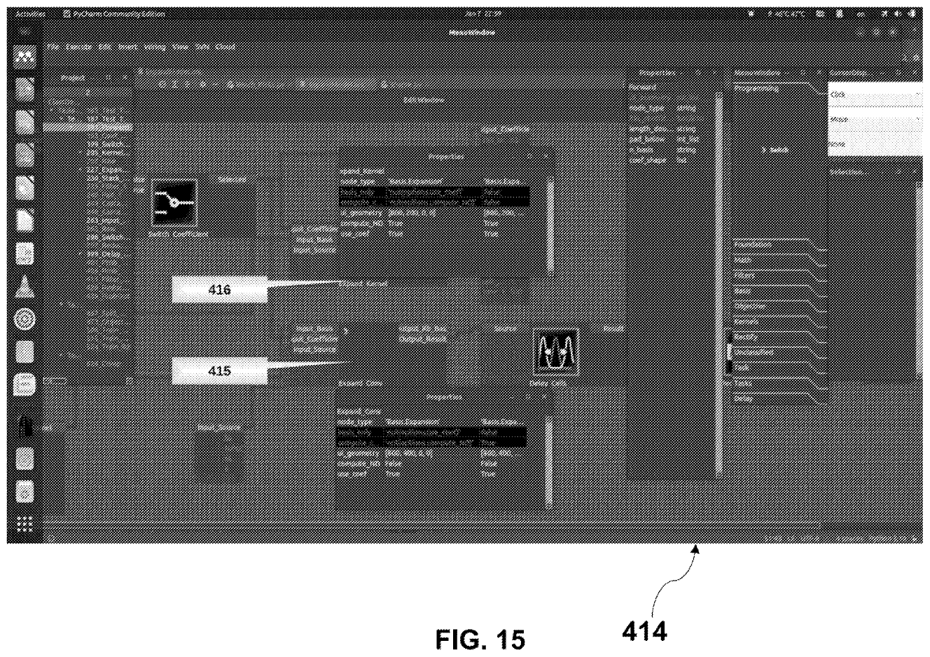

The graph further comprises an Expand. Kernel node 416 and an Expand. Conv node 415. Such nodes 415, 416 represent two instances of the Basis. Expansion class having different parameters. The nodes 415, 416 therefore share the same definitions. Any difference in between the graphs of the nodes 415 and 416 results from different parameters passed to the said nodes, as shown at FIG. 15. If the configuration of one of the nodes are edited, the change in the class definition shall propagate to other instances of the same class. Referring to FIG. 15, the first column represents the property name, the second column defines an expression and the third column is the value associated to the current context (see also section E of the present document).

The Expand.Conv node 415 is configured to perform most of the actual computation by filtering the input signal with the basis, pairwise multiply the filtering results for pairs of basis, and multiply aforementioned results with the coefficients. The Expand.Kernel node 416 is a visual aid that simultaneously filter a delta signal with the basis, putting time on different axis on each order, and apply the input coefficients, thus producing an N-dimensional (ND) visualization of the trained kernels. More details regarding operations are provided below.

Still referring to FIG. 13, the Expand. Conv 415 is connected to a delay estimator node 420. The delay estimator node 420 is configured to estimate a separate delay for each cell, before summing the results from all input cells to produce a single output 444. A cell may be represented an independent input signal, such as the cells referred at reference [3].

Referring now to FIG. 14, a convention system 413 is illustrated in action. A Kernel. Lagu node 443 produces the kernel in a two (2) dimensional array in the format of [time x channel]. The Expand node 415 requires a basis in the format of a 4D filter, in compliance with Tensorflow filter format. In order to accommodate such format, a match table [channel→channel_out] 445 is supplied to the highlighted (silver) linkage 460. The remaining dimensions are expanded automatically.

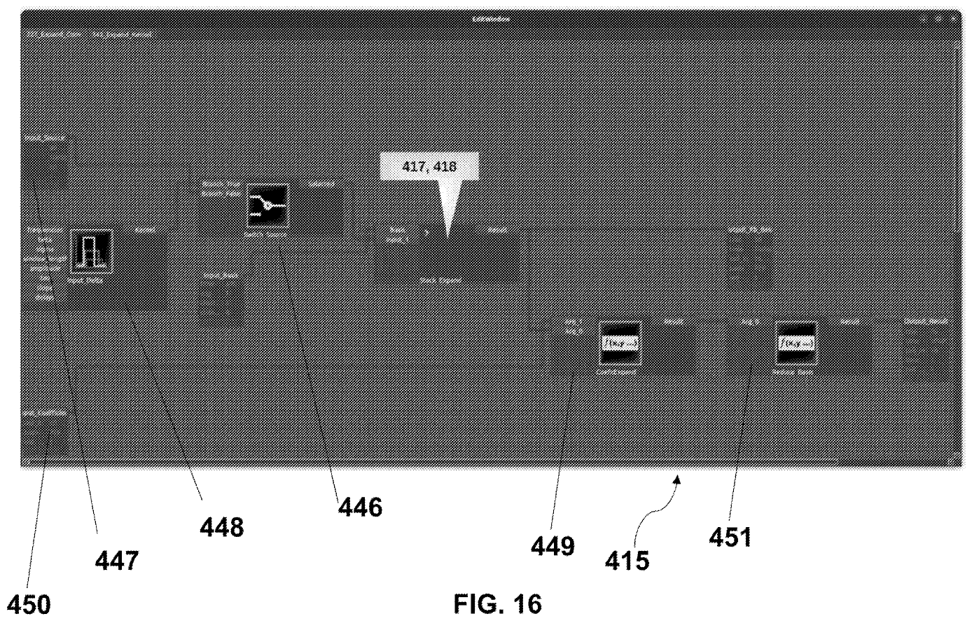

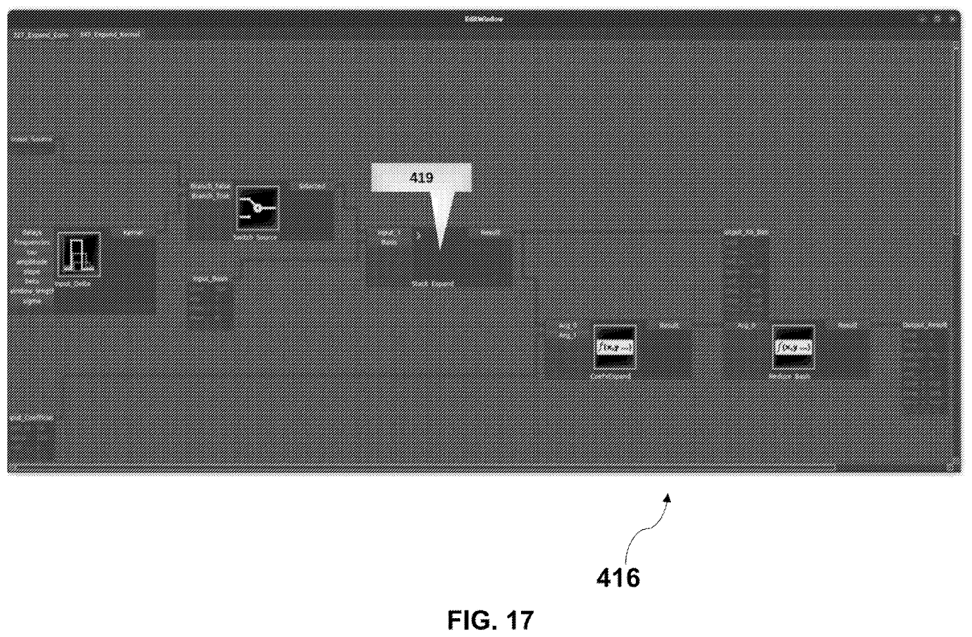

Referring to FIGS. 16 and 17, the graphs 415 and 416 each defines the Expand Class, as evaluated in the context of two instances defined above (as shown in FIG. 13). The graphs 415 and 416 comprise a selector 446. The selector 446 is configured to switch between two different input sources. The expansion node 417, 418 may receive an external input 447 or may receive a delta (spike) input 448. The Expansion.Stack node instance 417 or 418 is connected to the selector 446 and is configured to perform pairwise multiplications. Such operation is described in more details below and illustrated at FIGS. 2, 18 and 19 (417, 418, and 419). The Expansion Stack node 417 is connected to a multiplication 449 having incoming coefficient 450, and a summing operation 451 configured to generate a weighted sum. Once again 415 and 416 share the same class and definition, so editing one graph will automatically update the other.

In the third example, all the elements (nodes) and connections in the definition are present in both cases. In embodiments where one or more portions of the graph is/are omitted due to the parameters being passed, such portions of the graph will be disabled in the current instance. In some embodiments, the said portions being disabled could be displayed as grayed out.

Referring back to FIG. 2, a graph definition 417 for the stack is illustrated. The graph definition 417 comprises a convolution filter node 452, connected to a padding node 453. The padding node 453 is connected to a Cascade object 454. Each of the Cascade objects 454 is generated by a Loop during edition of the graph. The loop is typically represented as a loop meta node (see also section F of the present document).

Each Cascades object 454 comprises two inputs. In the illustrated embodiment, a first input is named StageThis 455 and is configured to directly receive result of the padding node 453. A second input 456, name StageLast is connected to the immediate predecessor node. The Cascade objects 454 are configured to compute pairwise product by manipulation of the convention system. In a normal operation mode, the Cascade objects 454 permute the “time” to the first dimension (0 based) and keep the 9 “basis” from the previous stage (StageLast) on the third dimension, while permuting the “basis” from the current input (StageThis) to the fourth dimension. By multiplying the two inputs 455 and 456, the padded result multiplies with a rotated version of itself by broadcast.

Broadcasting happens when a tensor with “1” on a particular dimension is matched with another tensor with some other size for that dimension. For example an element wise multiplication between tensor size of [5, 10] and [5, 1] in Tensorflow will automatically tile the second matrix 10 times, producing a result of [5, 10].

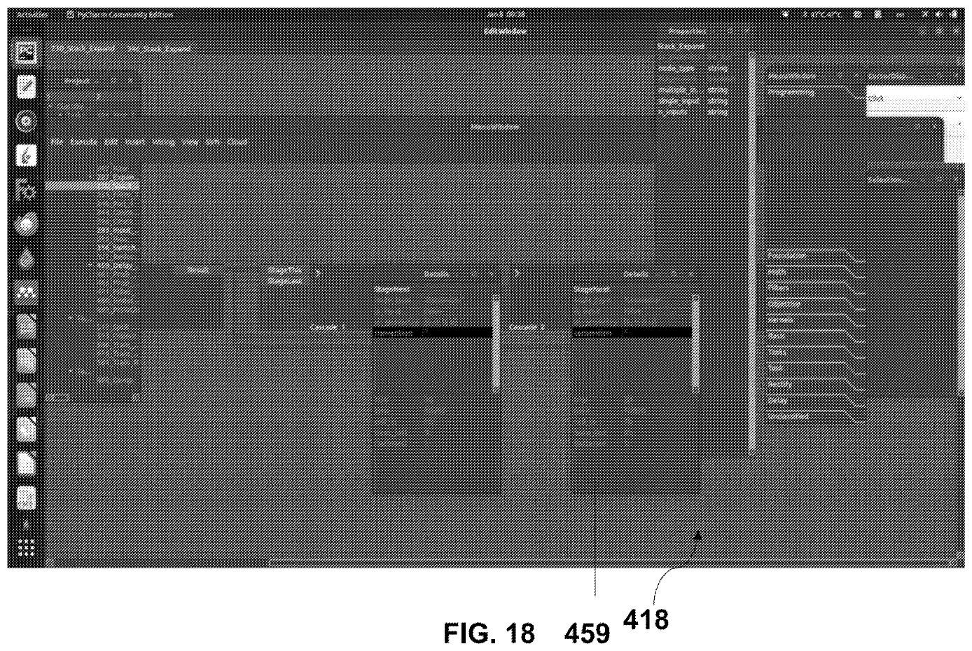

Therefore, in the present specific example, multiplying a matrix with the dimensions [30, 10000, 16, 9, 1] with [30, 10000, 16, 1, 9] will produce a result with the dimension [30, 10000, 16, 9, 9]. As the last two dimensions now amount to 9, the multiplication shall produce 81 pairs with each combination of basis present. Such example can be visualized by imagining the first matrix laying flat with basis along x dimension, while the time point away in the z dimension, and the rotated matrix will have the basis along y dimension, with the time pointing in the same z dimension. The cascade operation then proceeds by setting the fourth dimension to “flattened”, forcing the last two dimension to collapse onto the third. In the present example, such collapse produces a matrix having a dimension [30, 10000, 16, 81, 1], as shown in the second intermediate output 459 of FIG. 18. The method is then repeated to produce all possible products between the 81 first stage results and 9 first order filter results. Such repeated process produces 729 results as shown in the final output illustrated at FIG. 2.

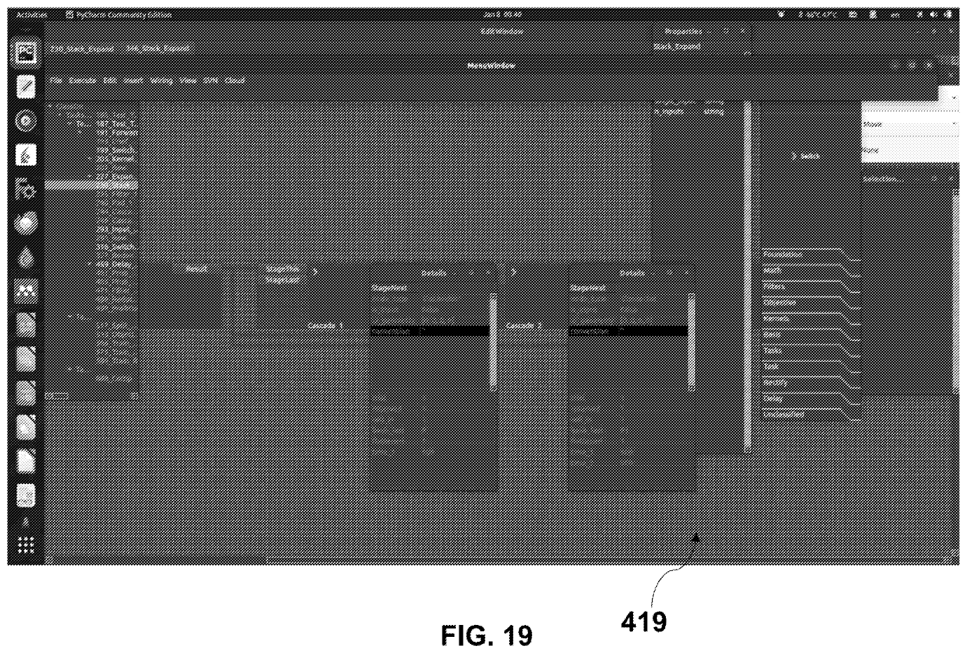

Referring to FIG. 19, in the visualization mode, the Cascade class moves “time” to a different dimension at each stage 419. Therefore instead of multiplying, ahigh dimensional representation is created. Because the input is a delta 448, the result will be the shape of the kernel in O dimensions. However visualizing such an object above in two dimensions is difficult in practice.

The padding node 453 adds a row of constant to the filtering result, regardless of the input. The padding 453 corresponds to the constant “zeroth” order kernel in the equation. A mathematical consequence of the padding node 453 is that the said padding node 453 inserts the lower level order kernel onto the first cross section of any higher order one. As the first signal is a constant, a copy of a first order kernel is performed, rather than creating a second order kernel, when multiplied with another first order kernel. Such operation allows the entire kernel to be represented by a single tensor rather than several with different dimensions.

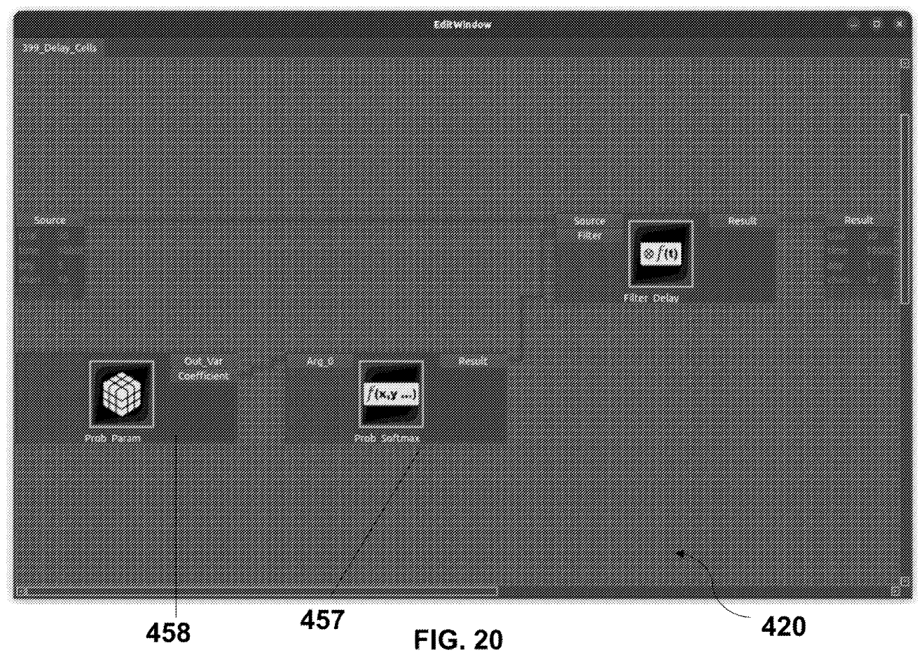

Referring now to FIG. 20, a graph definition for probabilistic delay 420 is illustrated. The parameter is a real valued function over time for each input cell. Neural networks are typically local optimization algorithm as they individually optimize probability of delay at each time t. Therefore, because of the filter, whenever delaying the kernel by t time unit would improve the prediction, the delay probability for t is increased.

A softmax function node 457 is connected to the probability variable 458 to enforce competition of the probabilities in time. The softmax node 457 is configured to divide the exponential of each probability by sum of exponential of all probabilities. A softmax node 457 is typically used because a delay is similar to selecting between mutually exclusive groups.

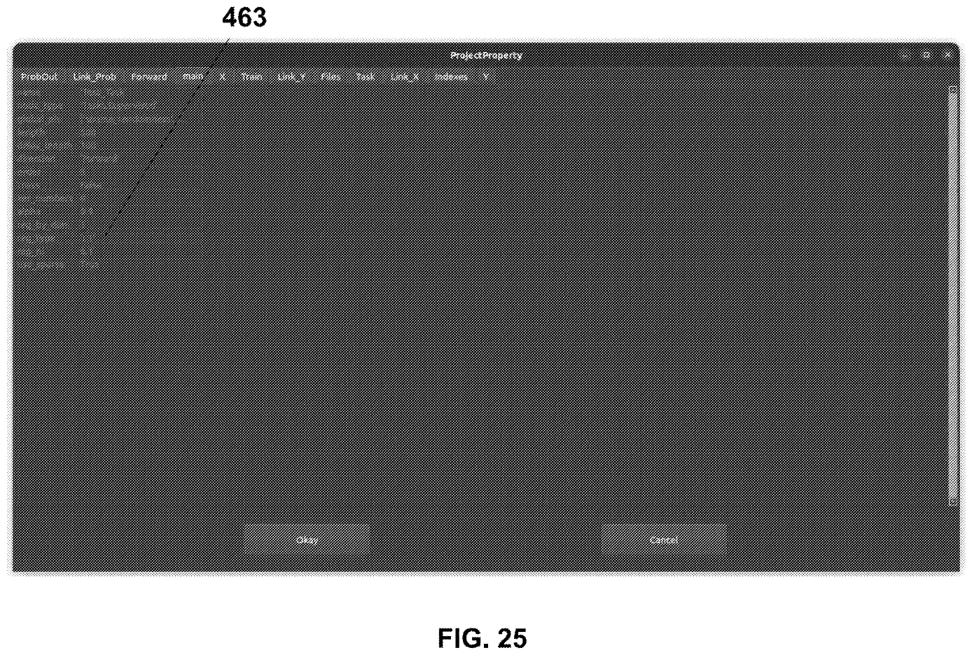

Referring to FIG. 23 or 25, in addition a L1 regularization 463, one of the project parameters, is placed on the delay probability variable 458. The regularization 463 causes unused probabilities to decay overtime. The combination of the softmax and regularization shall cause the delay to converge towards a delta function when the alpha value of the Laguerre Basis is set properly.

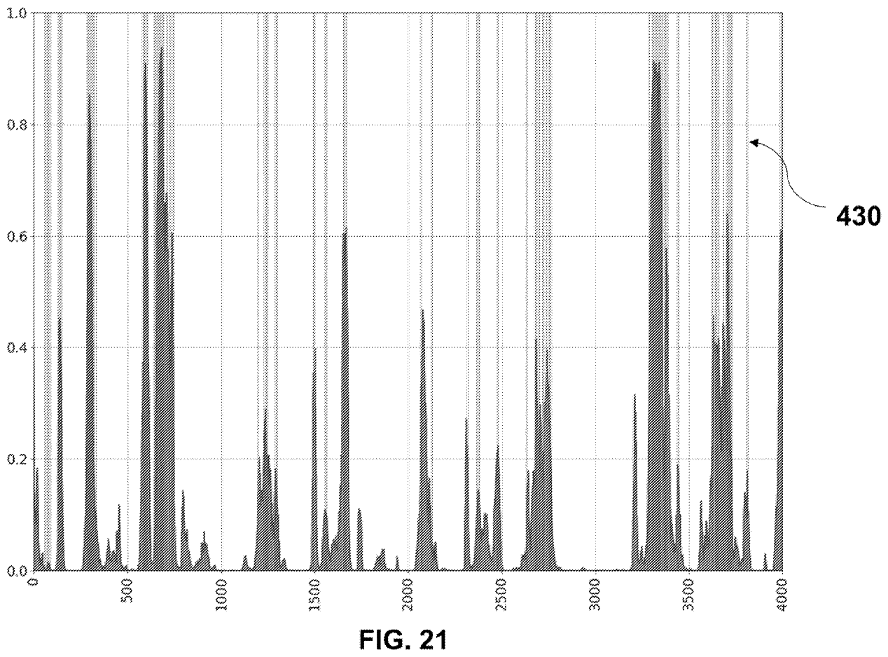

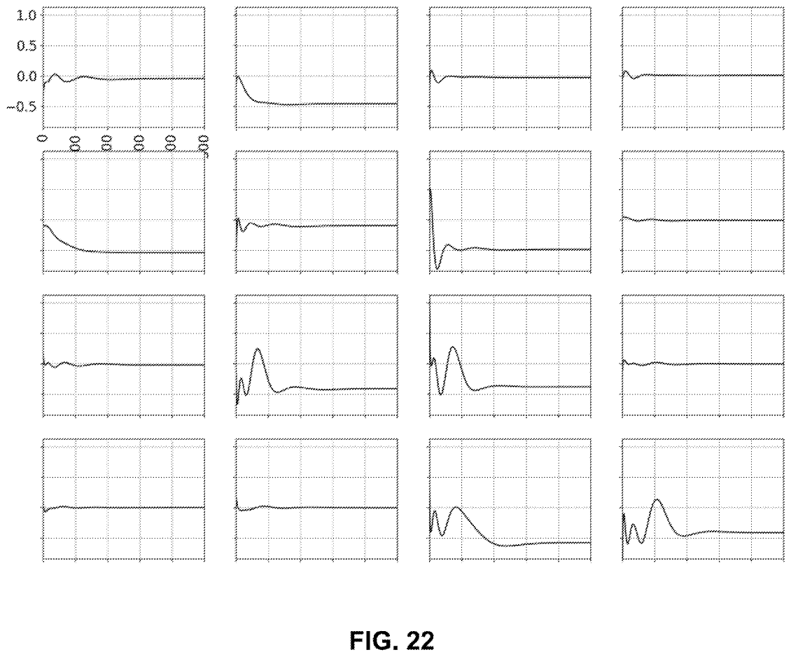

Referring now to FIG. 21, a sample prediction 430 from the validation set is illustrated. The validation set used the parameters trained on the training set. Light gray lines shown at FIG. 21 represent the location of target spikes to be predicted, and dark color shows the estimated probability. One shall notice the high coincidence of predicted high probability with regions with spikes and the predicted low probability with regions without. The poor prediction of the first group is due to the transient artifact caused by the length of the kernels, which are several hundred time units long (see FIG. 22). Understandably, a perfect prediction of the spike timing is impossible due to stochastic sampling of the probability to produce spike trains in the original problem.

Referring now to FIG. 22, the first order kernel recovered from the training data is illustrated. The said first order kernels may be compare with the shapes of the kernels presented in FIG. 6 of the original solution as described in reference [4].

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

### N. BIBLIOGRAPHY

[1] Y. Guo, M. Sahin, R. A. Foulds, S. V Adamovich, and M. Sahin, “Encoding of forelimb forces by corticospinal tract activity in the rat.,” Front. Neurosci., vol. 8, p. 62, January 2014, doi: 10.3389/fnins.2014.00062.
[2] M. Pala, “A New Human Voice Recognition System”, Accessed: Jan. 11, 2024. [Online]. Available: https://www.researchgate.net/publication/320673140
[3] V. Marmarelis, Nonlinear dynamic modeling of physiological systems. 2004. Accessed: Jan. 11, 2024. [Online]. Available: https://books.google.ca/books?hl=en&lr=&id=JgW3kL6beBgC&oi=fnd&pg=PA1&dq=nonlinear+dynamic+modeling+of+physiological+systems&ots=18Vvtcc5C2&sig=4hyqzHxjY1SrvlILXO-QRvUKC_0
[4] D. Song et al., “Identification of Sparse Neural Functional Connectivity using Penalized Likelihood Estimation and Basis Functions,” J. Comput. Neurosci., vol. 35, no. 3, p. 335, December 2013, doi: 10.1007/S10827-013-0455-7.

1. A machine-interpretable formal graphical representation of a class architecture of neural networks comprising classes, the formal graphical representation comprising:
hierarchical graphs representing the classes of the neural networks, each graph comprising graphical representation of nodes representing class instance of a class architecture and being defined by a set of parameters;
graphical links between the nodes, each link representing a flow of data between each of the nodes; and
convention associated with connectors of the nodes to match dimensions between the said nodes;
wherein the machine-interpretable formal graphical representation is configured to be complied and to create specific executable network using the said formal graphical representation and a list of hyper-parameter values.

2. The representation of claim 1, each node comprising at least one graphical representation of an input terminal or one output terminal; each of the terminals being associated to a class definition and comprising a convention having an ordered list of dimension names.

3. The representation of claim 1 further comprising a downstream link between the output terminal of a first of the nodes and the input terminal of a second of the nodes or an upstream link between the input terminal of the first of the nodes and the output terminal of the second of the nodes, the linked nodes creating the hierarchical graphs and depending on the parameters, wherein the formal graphical representation is adapted to dynamically create sub-architectures depending on the set of parameters.

4. The representation of claim 3, one or more of the links comprising a match table connecting a terminal using different names of another terminal, the terminals having the same dimensions.

5. The representation of claim 2, wherein the set of parameters defines relationships between the class definition and instances of the same.

6. The representation of claim 1, each class of the architecture comprising a set of default parameters, the default parameters being copied in each node being an instance of the said class.

7. The representation of claim 6, each node further comprising a set of specific parameters.

8. The representation of claim 1, at least one of the nodes being a sub-network node.

9. The representation of claim 8, the sub-network node comprising a plurality of inner nodes being connected to one another.

10. The representation of claim 1, the node being selected in the followings: an input or output connector, an instance of a class defined by a lower-level graph, a wrapper for an elementary operation and control flow containers.

11. The representation of claim 10, the wrapper performing a transpose or a convolution operation.

12. A system for designing a graphical class architecture of a neural network using the machine-interpretable formal graphical representation of claim 3, the system comprising:
a graphical user interface configured to display, add, move and edit graphical representations of the nodes, the terminals and the links;
a configuration module to organize the parameters of the nodes, terminals and links;
a library module configured to add a user-defined class and to load classes in correct dependency order; and
a building module to create a computational model based on the machine-interpretable formal graphical representation.

13. The system of claim 12 further comprising a convention module adapted to automatically match dimensions between two terminals using different names, the terminals having the same dimensions.

14. The system of claim 12, the configuration module being configured to copy default parameters of classes to the node.

15. The system of claim 14, the configuration module being configured to assign specific parameter to each of the nodes.

16. The system of claim 14, the configuration module being configured to propagate the parameters of upper level networks to sub-nodes.

17. The system of claim 12, the building module being configured to generate computational models using the created architecture.

18. A computer-implemented method for building a graphical class architecture of a neural network using a graphical user interface, the method comprising:
creating graphical nodes representing the class architecture of the neural network, the nodes being selected amongst any one of the followings: instance of a class of the architecture, upstream connectors, downstream connectors, flow control node and sub-network nodes;
creating a wire having two ends, each end being connected to an input terminal of one of the nodes to create a downstream connector or to an output terminal of one of the nodes to create an upstream connector;
setting or editing parameters associated to each created node or terminal of a node;
recursively analyzing the nodes to validate the graphically represented neural network architecture using the parameters; and
generating computational models using the created architecture and the parameters.

19. The method of claim 18 further comprising editing a sub-network node being an instance of a lower-level class.

20. The method of claim 19 further comprising displaying inner structure of the lower-level class as another graph using graphical representation of nodes, terminals and wires.

21. The method of claim 18, the generation of the computational models further comprising executing source code associated with each of the nodes based on a template associated to type of the node as a sequence.

22. The method of claim 18 further comprising storing the generated models using a standard format of the predetermined neural network framework.

23. The method of claim 18 further comprising training the generated neural network a plurality of times using different variations of test data.
